(19) United States
(12) Patent Application Publication
(10) Pub. No.: US 2019/0178672 A1
(43) Pub. Date: Jun. 13, 2019

(54) PERSONALIZED BICYCLE ROUTE GUIDANCE USING STORED PROFILE

(71) Applicant: Uber Technologies, Inc, San Francisco, CA (US)

(72) Inventor: Seth Alan Woolley, Portland, OR (US)

(21) Appl. No.: 15/836,457

(22) Filed: Dec. 8, 2017

(51) Int. Cl. G01C 21/36; G01C 21/34

(52) U.S. Cl. CPC G01C 21/3617; G01C 21/3415; G01C 21/3697; G01C 21/3635; G01C 21/3461

(57) ABSTRACT

One general aspect includes a computing apparatus, the computing apparatus including at least one processor and a memory storing instructions that, when executed by the at least one processor, configure the apparatus to perform operations including receiving motion pattern data relate to the cyclist, the motion pattern data having been generated by at least one sensor of a mobile device. The computing apparatus also generates, using the at least one processor, cycling profile data for the cyclist based on the motion pattern data. The computing apparatus automatically updating a stored cyclist profile, stored in a system database, for the cyclist using the cycling profile data. The computing apparatus receives a routing request to provide a route for the cyclist, the request including start location data and destination location data; responsive to receiving the routing request, the computing apparatus accesses the stored cyclist profile within the system database. The computing apparatus then personalizes route data for an automatically calculated route for the cyclist, using the stored cyclist profile.

### TECHNICAL FIELD

The subject matter disclosed herein generally relates to special-purpose machines that generate route guidance data for turn-by-turn route searching and guidance, and to the technologies by which such special-purpose machines become improved compared to other similar special-purpose machines. Specifically, the present disclosure addresses systems and methods for providing route guidance and route data generation.

### BACKGROUND

Automated route guidance (e.g., turn-by-turn route guidance or navigation) is a technology area that, while having undergone rapid advances in recent years, still presents many technical challenges, particularly considering data and environmental complexities. Some of these complexities arise from the need to route different types of vehicles (or modes of transport) through multiple different types of environments (e.g., rural, urban).

### BRIEF DESCRIPTION OF THE DRAWINGS

To easily identify the discussion of any particular element or act, the most significant digit or digits in a reference number refer to the figure number in which that element is first introduced.

FIG. 1 is a diagrammatic representation of a service delivery system, according to some example embodiments.

FIG. 2 is a block diagram showing details of records within map and user databases, according to some example embodiments.

FIG. 3 is a flowchart illustrating a method, according to some example embodiments, of responding to a service request within the context of a networked environment.

FIG. 4 is a diagrammatic representation of a mobile device, also showing data produced by components of the mobile device, according to some example embodiments.

FIG. 5 is a diagrammatic representation of a processing environment, in accordance with one embodiment.

FIG. 6 is a diagrammatic representation of a cycling unit showing a mobile device mounted on-bike and located on-body, according to some example embodiments.

FIG. 7 is a diagrammatic representation of a mobile device presenting route data including a shortcut segment and an excluded avoided route segment, according to some example embodiments.

FIG. 8 is a flowchart showing a routine, according to some example embodiments, to personalize calculated route data for a cyclist.

FIG. 9 is a flowchart illustrating a routine, according to some example embodiments, to personalize route segments using minimum cadence values for cyclist.

FIG. 10 is a flowchart illustrating a routine, according to some example embodiments, to personalize route segments using minimum cadence values for a cyclist.

FIG. 11 is a flowchart illustrating a routine, according to some example embodiments, to personalize calculated route data for a cyclist.

FIG. 12 is a flowchart illustrating a subroutine, according to some example embodiments, to process route segment data relating to a shortcut segment.

FIG. 13 is a flowchart illustrating a subroutine, according to some example embodiments, to process route segment data relating to a transit route segment.

FIG. 14 is a flowchart illustrating a routine, according to some example embodiments, to process map segment data relating to shortcuts.

FIG. 15 is a flowchart illustrating a routine, according to some example embodiments, to calculate personalized route data based on estimated physiological capacities of a cyclist.

FIG. 16 is a block diagram showing a software architecture, according to some example embodiments.

FIG. 17 is a diagrammatic representation of a machine in the form of a computer system within which a set of instructions may be executed for causing the machine to perform any one or more of the methodologies discussed herein, according to some example embodiments.

### DETAILED DESCRIPTION

### Glossary

“Carrier signal” in this context refers to any intangible medium that is capable of storing, encoding, or carrying instructions for execution by the machine, and includes digital or analog communications signals or other intangible media to facilitate communication of such instructions. Instructions may be transmitted or received over a network using a transmission medium via a network interface device.

“Communication network” in this context refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Basic Safety Bicycle Geometry” in this context refers to a common “safety bicycle” that is composed of a fork which holds a front wheel, a main triangle, and a rear triangle that holds a rear wheel (forming a diamond shape of two triangles). The rear triangle is composed of “stays”—a seat stay (upper) and a chainstay (lower), plus a seat tube. The main triangle joins with the rear triangle via the seat tube, and a down tube and a top tube meet at the head tube. Attached through the head tube to the fork, is a stem that clamps on to the handlebars.

“Cadence” in this context refers to pedaling rotation speed, usually in rotations per minute (RPM). Forward velocity, unless coasting (not pedaling and thus using inertia and/or gravity for forward progress), is a combination of cadence and gear length.

“Fixed gear” in this context refers to a bicycle with a single gear, avoiding the need for an idler gear (e.g., on a derailleur), and with no freewheel, so pedal rotation and rear wheel rotation are fully synchronized.

“Freewheel” in this context refers to a rear wheel hub that freely rotates in one direction (for coasting) and locks in the forward direction (for applying power), used for geared bikes. An ungeared bike that is a single speed bike can have a freewheel, too, but is termed a single speed bike, and not a fixie or fixed-gear bike.

“Gear length” in this context refers to the distance the bicycle travels with one full rotation of the pedals. This is a function of the driven wheel diameter and gear ratios based on front and rear tooth counts.

“Machine-storage medium” in this context refers to a single or multiple storage devices and/or media (e.g., a centralized or distributed database, and/or associated caches and servers) that store executable instructions, routines and/or data. The term shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Module” in this context refers to logic having boundaries defined by function or subroutine calls, branch points, application program interfaces (APIs), or other technologies that provide for the partitioning or modularization of particular processing or control functions. Modules are typically combined via their interfaces with other modules to carry out a machine process. A module may be a packaged functional hardware unit designed for use with other components and a part of a program that usually performs a particular function of related functions. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein. In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations. Accordingly, the phrase “hardware module” (or “hardware-implemented module”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time. Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information). The various operations of example methods and routines described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors. Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)). The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

“Processor” in this context refers to any circuit or virtual circuit (a physical circuit emulated by logic executing on an actual processor) that manipulates data values according to control signals (e.g., “commands”, “op codes”, “machine code”, etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC) or any combination thereof. A processor may further be a multi-core processor having two or more independent processors (sometimes referred to as “cores”) that may execute instructions contemporaneously.

“Signal medium” in this context refers to any intangible medium that is capable of storing, encoding, or carrying the instructions for execution by a machine and includes digital or analog communications signals or other intangible media to facilitate communication of software or data. The term “signal medium” shall be taken to include any form of modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“Transmission medium” in this context refers to any intangible medium that is capable of storing, encoding or carrying instructions for execution by the machine, and includes digital or analog communications signals or other intangible medium to facilitate communication of such software.

“Wheelbase” in this context refers to the distance between the front and rear wheel hubs of a bicycle.

### DESCRIPTION

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

Automated and computerized routing of different types of vehicles or modes of transport (e.g., trucks, cars, bicycles, and pedestrian transportation) through different types of environments (e.g., urban, suburban, rural) presents a number of technical challenges. Even within a single mode of transport, multiple different factors, both inherent in the mode of transport and introduced by the environment, can greatly increase the technical complexity of providing automated routing.

The automated routing of bicycles and motorbikes present a number of specific technical challenges in light of user behaviors, equipment variations, and environmental variables, as well as the types and nature of services that may be performed by a cyclist or motorbike rider. For example, an automated service delivery system (e.g., UBEREATS) may use bicycle riders (cyclists) to make deliveries within a particular urban environment (e.g., the city of San Francisco). The service delivery system may provide automated route guidance to a cyclist for delivery of a particular package or meal between a delivery origination (e.g., a parcel pickup location or restaurant) and a delivery destination (e.g., a consumer). In providing automated route guidance to a cyclist, certain example embodiments take into account variations in terrain (e.g., hills). Further embodiments also propose taking into account differences in both physical capabilities and characteristics of the cyclist, characteristics and attributes of a particular bicycle, and also characteristics and attributes of a particular cargo that the cyclist may be delivering.

When considering the above-identified characteristics and attributes (e.g., of the cyclist, the bicycle, and the cargo), it should be kept in mind that cyclists may use a wide variety of bicycles, having different gearing, power, and other capabilities in a trade-off for bicycle weight, etc. For example, a bike courier may choose a so-called fixed-gear bicycle to reduce weight and other factors. Many couriers use fixed-gear road bikes, instead of hill-climbing, mountain bikes, because they are lighter in weight. There are several reasons that a bike courier may choose a light and simple bike, over a heavier, more utilitarian bicycle. For example, couriers may regularly dismount and carry their bikes so as to enable them to take shortcuts (e.g., upstairs), thus saving time that would otherwise be required to lock up their bicycles at a delivery location. Couriers also typically desire higher maneuverability in traffic, which is facilitated by a lightweight bicycle (e.g., which has better acceleration), very narrow handlebars (e.g., to enable cutting between traffic), a short wheelbase (e.g., for enhanced maneuverability), an equilateral main triangle (e.g., to improve frame strength), short front shock angle (e.g., again to improve maneuverability and track standing ease), a fixed-gear set up, and skinny, light ties to reduce rotational mass and increase acceleration. In addition, cycling activities like curb hopping and wheelies are often easier with direct fixed drives. Additionally, fixed-gear bicycles may be easier to maintain, as they can use wider and stronger chains, have fewer moving parts, are cheaper to buy and generally break down less often. While fixed-gear bicycles are limited in low gears, bicycle delivery is often multi-modal and can involve walking up steep hills or simply powering through them. Having gears that are too low may be slower than a bike courier's ability to climb a hill by walking.

However, fixed-gear bicycles do require some trade-offs, and a bike courier may have a very difficult time ascending or descending a steep hill, particularly if the bicycle has a narrower minimum and threshold gear length. For this reason, some bike couriers may tend toward customizations that go to the other end of the spectrum, and may prefer a heavier bike that has more gears, or even an electric system motor.

In addition to the above-identified variations that can occur with respect to the bicycle, it should also be kept in mind that the physiological capabilities of bike couriers themselves may vary greatly. For example, a fit human cyclist can output between 200-300 Watts of power for relatively short bursts of around an hour or so. A strong cyclist will often burst for 600 Watts while hill climbing. Additionally, bike couriers may differ dramatically in weight, which can also have a significant impact on the ability of the courier to successfully ascend very steep hills. Certain bike couriers may also have significantly more athletic prowess than others, enabling them to take shortcuts that other bike couriers would not be able to physically undertake.

Turning now to the various environmental variations impacting the provision of automated route guidance, these variations introduce considerations for one mode of transport or commuting that differ significantly from other modes. For example, in an urban area, it may be possible to route a car through a tunnel that is not available or advisable for bicycle or foot traffic. Additionally, certain roads may have pedestrian facilities or bike lanes, whereas other roads may not. Bicycle traffic is rarely affected by other bicycle traffic in most major cities (with exception of major bike-friendly cities such as Amsterdam and Copenhagen). Bicycle traffic speeds are more often affected by car traffic that can vary depending on bike infrastructure. For example, separate and parallel bike infrastructure, such as truly separate tracks or undivided (painted) lanes, can help reduce interactions with cars. Shared car and bike lanes may or may not be lane splittable, or have room to get around stalled traffic.

Cyclists, and in particular bike couriers, are also particularly adept at finding “shortcuts,” that are available to cyclists and pedestrians, but would not be available to car traffic. However, certain of these shortcuts that are taken by bike couriers may be explicitly prohibited, or otherwise undesirable to include in automated routing for other reasons. For example, certain shortcuts may simply be unsafe. In addition, variations in shortcuts may make them more or less desirable for different classes of bicycles. A gravel shortcut may be suitable for a bicycle having a wide tire, but less so for a bicycle having narrow tires. Similarly, a shortcut involving a stair climb may be suitable for a light bicycle, but undesirable for a heavy bicycle, such as an electric motor assist bicycle (a.k.a., e-bike).

Turning now specifically to cargo that a bike courier may be required to deliver, these cargoes can also vary significantly in weight and dimensions. The ability of a bike courier to use a particular shortcut, or successfully ascend a particularly steep hill, may be significantly impacted by the physical properties of a cargo that the courier is tasked with delivering.

Example embodiments seek to take into account variations in equipment (e.g., the bicycle itself), the cyclist (e.g., the physiological characteristics and attributes of the cyclist), and/or a delivery cargo in customizing and optimizing automated routing guidance. While the example embodiments discussed herein focus mainly on the routing of bicycles, these embodiments may find equally useful application in routing for other modes of transport or movement (e.g., motorcycle transportation or pedestrian movement).

### DRAWINGS

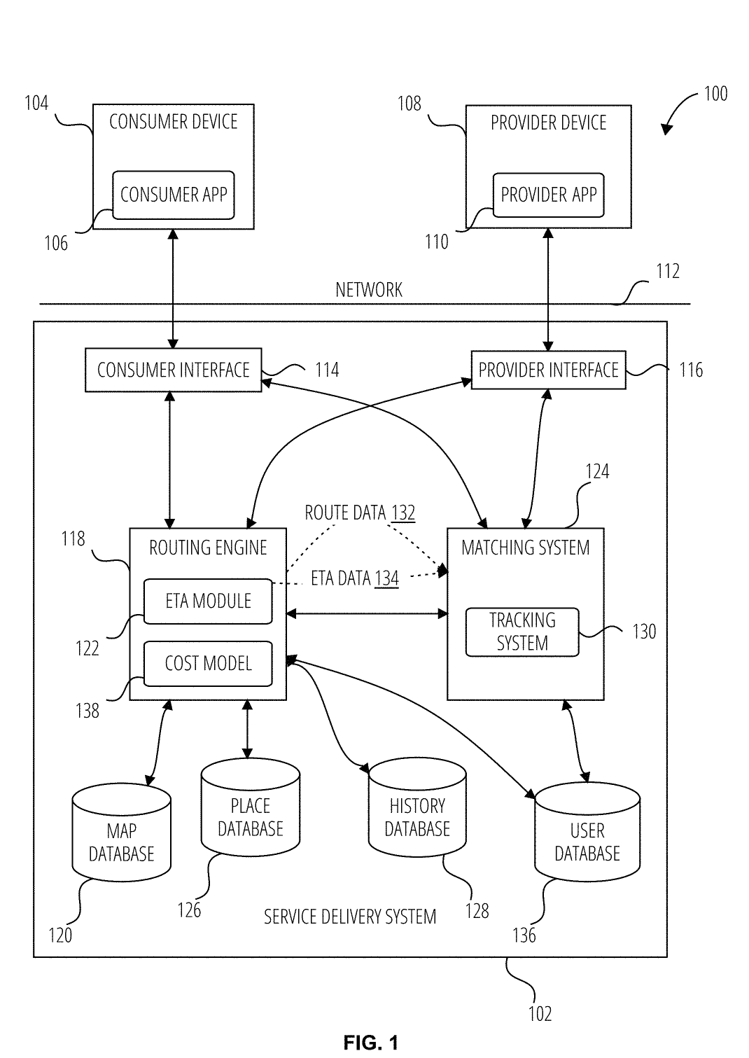

FIG. 1 is a diagrammatic representation of a service delivery system 102, operating within a networked environment 100, according to some example embodiments. The service delivery system 102 operatively facilitates delivery of a service by a service provider to a service consumer. In some example embodiments, the service delivery system 102 is dedicated to a particular vertical and may focus on the delivery of a single service (e.g., a transportation service for the transportation of either persons or goods). In other embodiments, the service delivery system 102 operates to enable the delivery of services across a range of different verticals and service types. A service provider may be a human service provider, a fully automated service provider, or a combination thereof. For example, where the service provider is a transportation service, the transportation vehicle may be a human-piloted vehicle, such as an automobile or aircraft, a fully autonomous vehicle, or a combination of human-piloted and autonomous vehicles may be deployed to deliver the transportation service.

FIG. 1 shows the service delivery system 102 to be communicatively coupled via a network 112 to both a service consumer device 104 and a service provider device 108. The consumer device 104 hosts and executes a service consumer application 106, while the provider device 108 hosts and executes a service provider application 110. In one embodiment, the consumer device 104 is a mobile computing device (e.g., a mobile telephone), executing a consumer application 106 downloaded from an appropriate app store (e.g., the Uber application that executes on either iOS or the Android operating systems). Similarly, the provider device 108 may be a mobile computing device, and the provider application 110 may be an application designed to run on a mobile operating system (e.g., iOS or Android operating systems). The service delivery system 102 may also interface with other types of devices, such as desktop computers, third-party service systems, and cloud-based computing systems.

The service delivery system 102 includes a consumer interface 114 (e.g., an appropriate set of Application Program Interfaces (APIs)) for facilitating communications, via the network 112, with the consumer device 104. Similarly, a provider interface 116 (e.g., again, a suitable set of APIs) facilitates communications between the service delivery system 102 and the provider device 108.

In the example embodiment in which the consumer interface 114 and the provider interface 116 comprise APIs, these APIs may also facilitate interactions between the service delivery system 102 and third-party applications hosted on various devices. For example, where the service delivery system 102 is a transportation service system, third-party applications may include widgets or buttons that enable a user to specify and deliver a service request from the third-party application to the transportation service.

The consumer interface 114 is communicatively coupled, and provides interactive access, to both a routing engine 118 and a matching system 124 of the service delivery system 102. Similarly, the provider interface 116 is communicatively coupled, and provides interactive access, to both the routing engine 118 and the matching system 124. At a high level, the routing engine 118 operatively generates route data to facilitate the provision of services from a service provider to a service consumer. For example, the routing engine 118 may generate route data 132 to route a service provider to a location at which a service consumer is located or vice versa. Further, where the service is transportation service (e.g., of a person or a good), the routing engine 118 generates route data 132 to assist the service provider in delivering the transportation service. The routing engine 118 further includes an estimated time of arrival (ETA) module 122 that generates ETA data 134. The ETA data 134 may relate to the ETA of a service provider at a service consumer (e.g., a driver at a pickup location for a passenger), the ETA of a consumer at a service provider location (e.g., where a consumer travels to a service provider location for delivery of the service), or an ETA for the destination arrival for a transportation service (e.g., the drop off of a passenger or delivery of a cargo).

In order to generate the route data 132 and ETA data 134, the routing engine 118, in addition to receiving information from the consumer device 104 and provider device 108, has access to a map database 120, a place database 126, a history database 128, and a user database 136. The map database 120 contains records for transportation infrastructure (e.g., data reflecting a road network, rail network, or other transportation route network). In one embodiment, the map database 120 may include OpenStreetMap (OSM) data or other proprietary road network data. In one embodiment, the routing engine 118 may include an Open Source Routing Machine (OSRM) engine or any one of several other proprietary routing engines.

The routing engine 118 may also deploy a number of segment cost models (e.g., cost model 138), algorithms and data processing techniques in order to generate the route data 132 and the ETA data 134. In one embodiment, the routing engine 118 uses an informed search algorithm, such as A*, to perform low-cost pathfinding and graph traversal by attributing costs of paths or segments between nodes on a graph map (e.g., generated from the map database 120 and the place database). The routing engine 118 may use dynamic contraction hierarchies as part of a routing algorithm. Sharding (e.g., breaking up graphs into geographic regions) may also be used to improve the performance, while the A* or Dijkstra's search algorithm with heuristics, may be used to prioritize nodes in a graph map to generate the route data 132.

The routing engine 118, as will be described in further detail below, may also attribute different costs to segments (or adjust the costs of segments), based on various observed (e.g., in near real-time) or known characteristics of an area to be traversed (e.g., the grade or surface condition of a road) and/or a vehicle (e.g., a cycling unit described herein, that includes the cyclists, a bicycle, and potentially a cargo). In some example embodiments, the routing engine 118 may adjust the cost of a segment based on a minimum cadence value or maximum power value of a cyclist. In a further embodiment, the cost of a segment may be adjusted based on a stated intention of a cyclist to ride for a duration or distance during a particular day or other time periods. In yet other embodiments, an expressed or observed affinity/aversion for certain types of segments (e.g., shortcuts or dirt roads) by the cyclist may be used to perform adjustments to the costs of segments on demand and in response to a request for routing data.

The map database 120 stores map data according to various formats and standards, such as the road or route map data roads and transport links formatted as an OSM file. The map data may conform to topological data structures and include multiple types of map data primitives, such as segments, nodes, ways, and relationships. Furthermore, the map database 120 may store Open cyclist Map (OCM) data, this data complying with a map format developed for cyclists and used by OSM. These maps include key information for cyclists, such as national, regional, and local roads, as well as cycle paths and footpaths. Records within the map database 120 may be formatted as .OSM files, or as shapefiles, which is a format used for storing vector geographic data. Further, the data within the map database 120 may use a topological data structure (e.g., when formatted as an OSM file), with multiple core elements or data primitives. Specifically, these data elements include nodes (points with a geographic location, stored as latitude and longitude coordinates), ways (ordered list of nodes representing a polyline or possibly a polygon), relations (ordered lists of nodes, ways and relations, where each member can have a “role”), and tags (key-value pairs used to store metadata about map objects). Other examples of map data include HERE TECHNOLOGIES map data (Nokia), TELE ATLAS map data (TomTom), or GOOGLE MAP data.

The place database 126 includes place data in the form of records for various places and locations, these records being used to supplement the map data from the map database 120 when generating the route data 132. Specifically, a place record within the place database 126 includes multiple names or other identifiers for specific locations (e.g., a restaurant or a shop), as well as latitude and longitude information. This place data may be used to more accurately identify a location specified in a request received from either a service consumer or provider.

The history database 128 stores historical information regarding past trips (e.g., GPS trace routes, logs and reroute incidents). This historical information is used by the routing engine 118, and more specifically the ETA module 122, in order to generate accurate ETA data 134. For example, historical data within the history database 128 may be used by the ETA module 122 to modify or adjust ETA data 134, based on historical traffic patterns within segments of a particular route.

The matching system 124, in one example embodiment, operates as a dispatch system. Specifically, the matching system 124 operatively matches a service request, received from a consumer device 104, with an available service provider. When operating as a dispatch system, the matching system 124 may match a particular service consumer with a particular service provider based on a number of factors, such as the geographic proximity of the respective parties and the current or future availability of the relevant service provider. To this end, the matching system 124 accesses tracking system 130, which receives input from the provider device 108 regarding a current geographic location of a service provider, as well as geographic location information from the consumer device 104 regarding the current location of a consumer. The tracking system 130 actively communicates geographic location information regarding either a consumer device 104 and/or a provider device 108 to the ETA module 122, both prior to and during a service delivery operation, to enable the ETA module 122 to dynamically update ETA data 134. The matching system 124 actively communicates updated ETA data 134 to both the consumer device 104 and the provider device 108.

To perform service matching operations, the matching system 124 is communicatively coupled to, and has access to, the user database 136. The user database 136 maintains user records for both service providers and service consumers. The routing engine 118 likewise has access to the user database 136 and, as will be described in further detail herein, uses user profile information maintained within the user database 136, to personalize the route data 132 for either a service consumer or a service provider (e.g., a transportation service provider). The examples described herein are focused specifically on the personalized calculation of route data 132 for a service provider who is a cyclist (e.g., a bike courier).

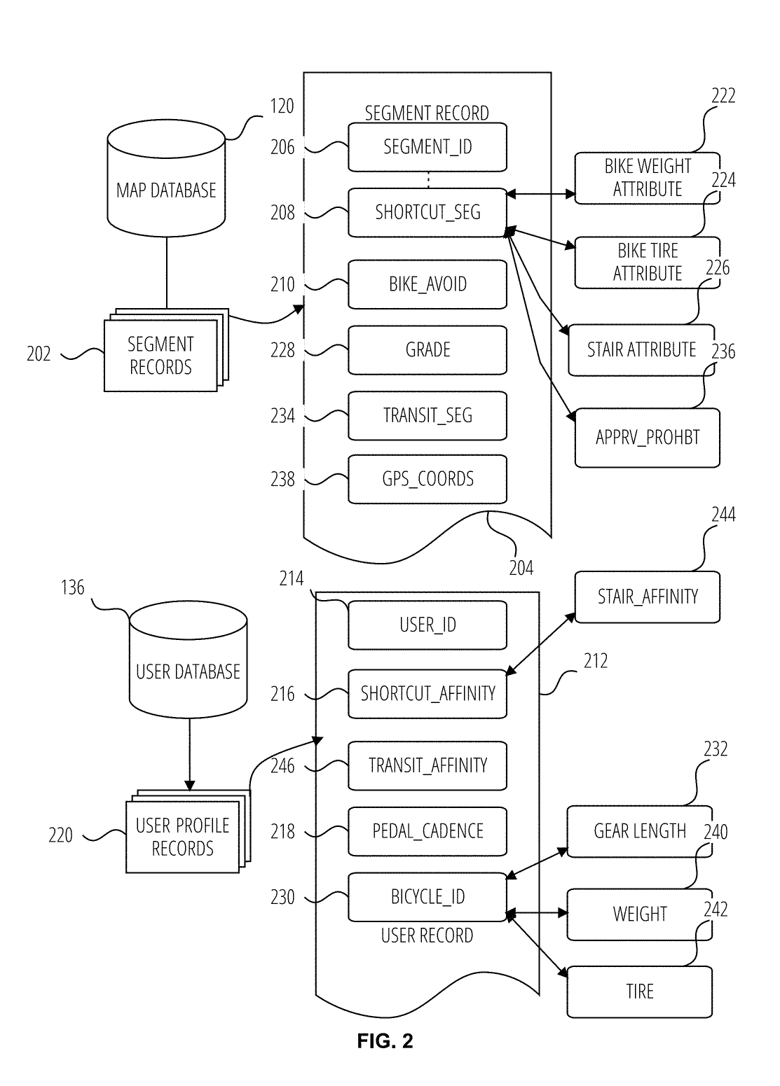

FIG. 2 is a block diagram illustrating further details regarding records within both the map database 120 and the user database 136, according to example embodiments.

As noted above, the map database 120 stores map data in various formats and standards (e.g., the OSM file format). In the current example, road or route map data is divided into several segments represented by segment records 202. Each segment record 204 stores numerous data items (e.g., metadata) pertaining to a particular road or route segment (e.g., multiple GPS coordinates for the segment, speed limit data, one-way data, two-way data). Furthermore, to facilitate the calculation of route data 132, the segment records 202 reflect a hierarchical order (e.g., with highway road segments having a higher order in the hierarchy than non-highway road segments). In FIG. 2, each segment record 204 is shown to include a unique segment identifier 206. In addition to other metadata, according to some example embodiments, each segment record 204 also includes a shortcut segment identifier 208 that uniquely identifies an associated route segment as being a “shortcut,” and a bicycle avoidance identifier 210 that identifies the associated segment as being a segment to be avoided when routing bicycle traffic. For example, where the relevant segment is a tunnel not having dedicated bike lanes, or which is otherwise dedicated only to automotive traffic, the relevant segment may be flagged by the bicycle avoidance identifier 210 as to be avoided for the routing of bicycle traffic. The methods and routines for the generation and use of the shortcut segment identifier 208 and bicycle avoidance identifier 210 are further described herein.

Various shortcut values may be attributed to the shortcut segment identifier 208 to further specify the nature of the relevant shortcut. For example, the shortcut segment identifier 208 may include a bike weight attribute 222 indicative of a maximum bicycle weight feasible for usage of the relevant shortcut. A bike tire attribute 224 indicates an optimal, recommended or constraining bike tire property that is suitable for the relevant shortcut segment. For example, a particular shortcut may be appropriate for bicycles with a wide tire, but not a narrow tire. This attribute may be included in the shortcut segment identifier 208, or otherwise associated with the shortcut segment identifier 208, and accordingly available for the calculation of the route data 132. Similarly, a stair attribute 226 may be included in or associated with the shortcut segment identifier 208 to indicate whether the particular shortcut involves stair climbing.

FIG. 2 also shows that the user database 136 stores multiple user profile records 220, each user record 212 being for either a service provider or a service consumer. The service providers, in some example embodiments, may be human service providers, automated service providers, or a combination thereof. Each user record 212 stores multiple attributes and information regarding a particular user and is uniquely identified by an appropriate user identifier 214. In certain example embodiments, each user record 212 also includes a shortcut affinity variable 216, a transit route affinity variable 246, and a pedal cadence variable 218. In the case of a service provider, the shortcut affinity variable 216 provides an indication of an affinity of the relevant user for using “shortcut” segments. In the scenario in which a particular user record 212 is for a bike courier (as an example of a service provider), the shortcut affinity variable 216 may provide a numeric indication of an “affinity” (e.g., historical interest, or a calculated capability) of the bike courier to use shortcuts when performing a transportation delivery service. The shortcut affinity variable 216 may be composed of, or calculated using, attributes such as a bike weight attribute 222, a bike tire attribute 224, and a stair attribute 226. The shortcut affinity variable 216 may be a historical affinity attribute that is automatically calculated based on past observed behaviors of the bike courier and the bike courier's past willingness to use shortcuts. In addition, the shortcut affinity variable 216 may be calculated using (or otherwise reflect) the weight of a bicycle used by the relevant bike courier, as well as bike tire characteristics or attributes of the courier's bicycle.

The transit route affinity variable 246 similarly provides a numeric indication of an “affinity” (e.g., historical interest, capability or propensity) of the relevant user to make use of transit options (e.g., train or boat transit options) when traveling. As will be described in further detail below, a value for the transit route affinity variable 246 may be automatically calculated based on stored historical or real-time location data captured during travel (e.g., a cycling trip).

A pedal cadence variable 218, in some example embodiments, is a calculated minimum cadence value for a cyclist. The pedal cadence variable 218 is used to automatically generate and calculate route data 132 for a cyclist user (e.g., bike courier), associated with the particular user record 212. Further details regarding the automated calculation of a minimum cadence value, as well as the use of this value in route optimization, are further described herein.

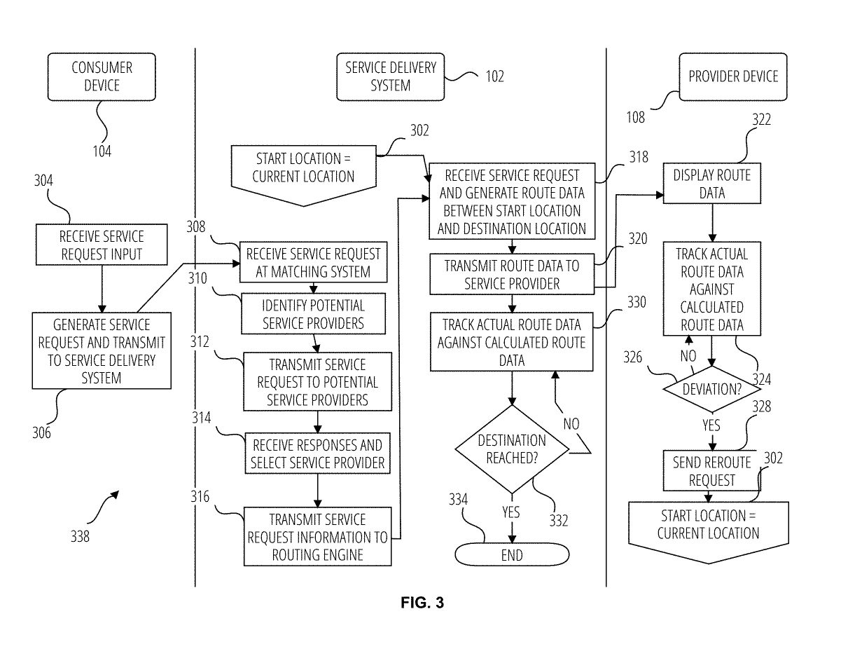

FIG. 3 is a flowchart illustrating a routine 338, according to some example embodiments, to process a service request within the context of the networked environment 100. The service request may be for any one of several services, such as a transportation service for either persons or goods. The routine 338 will be discussed within the context of processing a transportation service request, merely for example.

The routine 338 commence at block 304, with the receipt of a service request from a consumer user via the consumer application 106 hosted on the consumer device 104. For example, a consumer user may input a request for transportation from a start (or origination) location to an end (or destination) location, these locations and further specifics of the service request being inputted via an appropriate user interface of the consumer application 106.

At block 306, the consumer application 106 generates a formatted and digital service request (e.g., as a service request message) that is transmitted from the consumer device 104 to the service delivery system 102. Specifically, the consumer application 106 may access the consumer interface 114 to transmit the service request message to the service delivery system 102.

At block 308, the service delivery system 102 receives the service request, and begins processing thereof at the matching system 124. This processing includes, at block 310, identifying potential service providers. Depending on the type of service request, various different criteria relating to both the service consumer, service providers and external factors (e.g., weather) may be used in the identification of potential service providers. In the case of a transportation service request, information included in the service request itself (e.g., the current location of the service consumer, the type of vehicle required), and information regarding service providers (e.g., current or anticipated distance from the current location of the service consumer or specified pickup location) may be used to identify potential service providers.

At block 312, the service delivery system 102 transmits a modified service request (e.g., supplemented with additional information) to the identified potential service providers. Specifically, the matching system 124 transmits the request by the provider interface 116 to the provider application 110, executing on the provider device 108, of each of the identified potential service providers. The transmission of the modified service request may be performed in phases or stages, with the service request first being sent to service providers within a predetermined proximity (e.g., a specific radius) relative to the start location (e.g., pickup location of the service consumer). In the absence of any responses or matches of service providers within the predetermined proximity and/or within a predetermined time period, the modified service request may then be transmitted to further service providers located at a greater distance from the start location.

At block 314, the matching system 124 receives responses from one or more service providers, again via the provider interface 116 and selects a particular service provider. This a selection may be on a first-come, first-serve basis, and may also be based on further criteria pertaining to the service provider (e.g., by comparing potential routes weighing/costs for different providers (e.g., couriers) using the same cost considerations laid out below).

Having selected the service provider, at block 316, the matching system 124 transmits the service request information to the routing engine 118, which at block 318, generates route data 132 to route the service provider between the start location and the destination location. In certain embodiments, this route may be personalized based on certain characteristics and attributes of the service provider (e.g., where the service provider is a bike courier, physiological attributes such as glycogen depletion and ability to ascend a steep hills,), as well as characteristics of a cargo (e.g., the weight of a package or person being transported), and other real-time characteristics of route options between the start and destination locations (e.g., vehicle traffic, weather, mass transit options). Further details regarding the personalization of the route data 132 are discussed in further detail with reference to other figures.

At block 320, the routing engine 118 then transmits the personalized route data 132 to the matching system 124 and to the provider device 108 via the provider interface 116. In addition to generating the personalized route data 132, the ETA module 122 also generates the ETA data 134, which is likewise provided to both the matching system 124 and the provider device 108.

At block 322, the provider application 110 displays the personalized route data and navigation information (e.g., turn by turn directions) to the consumer user.

At block 324 and block 330, both the service delivery system 102 and the provider device 108 track actual route data (e.g., determined by a GPS component of the provider device 108) against the calculated route data transmitted at block 320. Assuming a deviation of the actual route data relative to the calculated route data is detected (e.g., at decision block 326), the routine loops back to block 318 where fresh route data between a current location and the destination location is calculated. In one embodiment, this may include, at block 328, the provider device 108 sending a fresh routing request to the service delivery system 102, wherein the start location for the routing is set to be the current (deviated) location of the provider device 108.

At decision block 332, a determination is made as to whether the location of the provider device 108 corresponds to the destination location, thus indicating that destination has been reached by the service provider. If not, tracking of the actual route data against the calculated route data continues. On the other hand, if the destination location is determined to have been reached, the routine ends at done block 334.

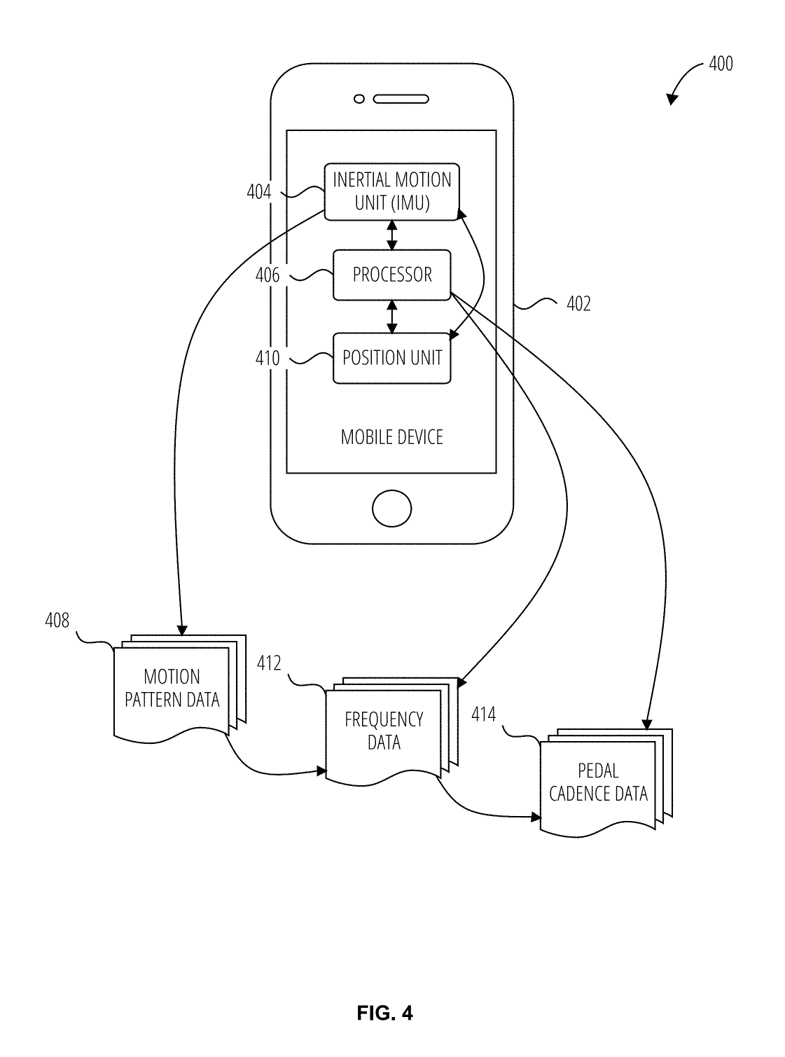

FIG. 4 is a diagrammatic representation on a mobile device (e.g., a consumer device 104 or a provider device 108), showing some internal components, as well as data that may be generated and processed by these various components. Specifically, the mobile device 402 is shown to include an inertial motion unit (IMU) 404, a general-purpose processor 406, and a position unit 410. The inertial motion unit (IMU) 404 may be a single unit within the mobile device 402, which operatively collects both angular velocity and linear acceleration data to generate motion pattern data 408, which is communicated to the processor 406. To this end, the inertial motion unit (IMU) 404 may be comprised of multiple sensors, including an accelerometer and an angular rate sensor. The accelerometer operationally generates three or more analog signals describing the acceleration of the mobile device 402 along each of three or more axes. The angular rate sensor also outputs three or more analog signals, describing the angular rate of the mobile device 402 about each of three or more axes. In those embodiments, the inertial motion unit (IMU) 404 may also generate data indicative of both linear and angular motion. The inertial motion unit (IMU) 404 may also include a gyroscope to generate rotational motion data.

The motion pattern data 408, accordingly, may include data indicative of both a side-to-side motion and back-and-forth motion of the mobile device 402 into which the inertial motion unit (IMU) 404 is incorporated. The motion pattern data 408, as noted above, is communicated from the inertial motion unit (IMU) 404 to the processor 406, which generates or derives frequency data 412 from the motion pattern data 408, which is in turn used to estimate pedal cadence data 414.

While the various types of data (e.g., motion pattern data 408, frequency data 412, and pedal cadence data 414) are shown in FIG. 4 to be generated by the processor 406 of the mobile device 402, in other embodiments, the data from the inertial motion unit (IMU) 404 (e.g., the motion pattern data 408) and the position unit 410 may be communicated to the service delivery system 102, and the processing of the motion pattern data 408 to generate the frequency data 412, and the pedal cadence data 414 may be performed server-side by one or more processes that are part of the service delivery system 102.

The position unit 410 (e.g., a global positioning system (GPS) sensor) is also shown to be communicatively coupled to both the processor 406 and the inertial motion unit (IMU) 404. In one example embodiment, the position unit 410 provides a signal to the inertial motion unit (IMU) 404, based on determining that the mobile device 402 is moving at a speed indicative of a bicycling trip. Responsive to this signal, the inertial motion unit (IMU) 404 begins to collect and generate the motion pattern data 408. In other words, the capturing of the motion pattern data 408 by the inertial motion unit (IMU) 404 is responsive to a determination that a bicycle, or cyclist, with which the mobile device 402 is associated has begun a cycling trip (e.g., that the relevant cyclist is in motion). Furthermore, the signal to the inertial motion unit (IMU) 404 to begin capture of the motion pattern data 408 may come from the position unit 410, or from the processor 406 responsive to input from the position unit 410.

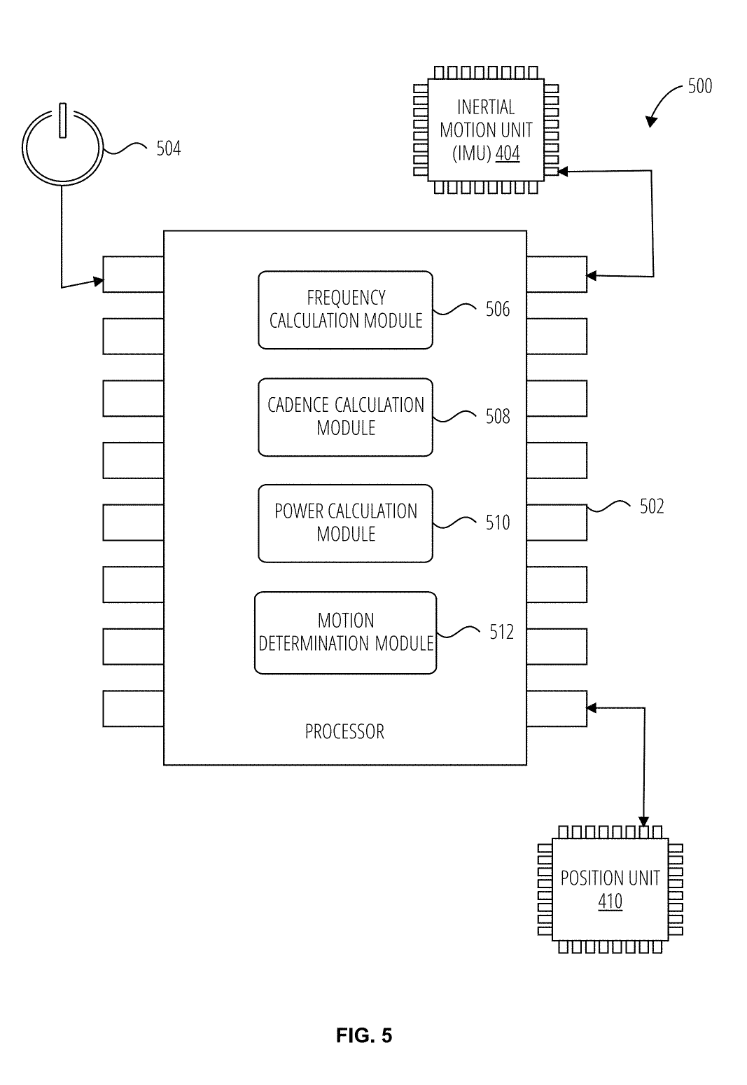

Turning now to FIG. 5, there is shown a diagrammatic representation of a processing environment 500, which includes the inertial motion unit (IMU) 404, the position unit 410, and a processor 502 (e.g., a GPU, CPU or combination thereof). In one embodiment, the processor 502 is the processor 406 of the mobile device 402, while in other embodiments, the processor 502 may form part of the service delivery system 102, and be located server-side.

The processor 502 is shown to be coupled to a power source 504, and to include (either permanently configured or temporarily instantiated) modules, namely a frequency calculation module 506, a cadence calculation module 508, a power calculation module 510, and a motion determination module 512. The frequency calculation module 506 operationally generates the frequency data 412, the cadence calculation module 508 operationally generates the pedal cadence data 414, and the power calculation module 510 operationally generates the power data. As illustrated, the processor 502 is communicatively coupled to both the inertial motion unit (IMU) 404 and position unit 410, and receives the motion pattern data 408 from the inertial motion unit (IMU) 404, as well as location data (e.g., GPS data) from the position unit 410.

The motion determination module 512 operationally processes location data received from the position unit 410 and determines, based on this location data, whether a cycling trip has been initiated by a cyclist or bicycle carrying the mobile device 402.

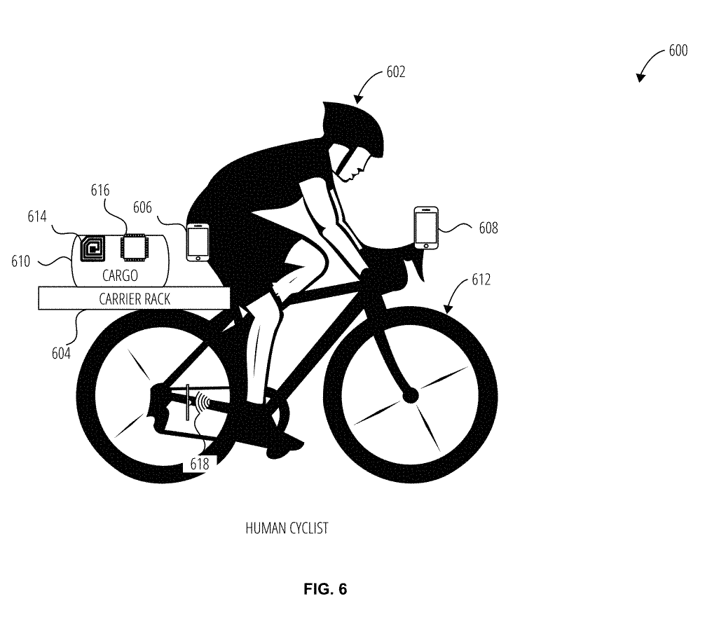

FIG. 6 is a diagrammatic representation of a cycling unit 600, which includes a cyclist 602 mounted on and peddling a bicycle 612. Various examples of routines and methods will be discussed below with reference to the cycling unit 600. Again, while certain examples are discussed with reference to the cycling unit 600, other examples may find application in other contexts and with respect to other modes of transport and other service delivery verticals.

The bicycle 612 has an attached carrier rack 604, which is carrying cargo 610 (e.g., a package or take-out meal). The cycling unit 600 is additionally shown to include a mobile device, in the form of either a body-mounted mobile device 606 or a bike-mounted mobile device 608, associated therewith. For example, the body-mounted mobile device 606 may be carried in an article of clothing (e.g., in a pant or jacket pocket). The bike-mounted mobile device 608 may be attached to the bicycle 612 by any one of several commercially available mounting devices, which served to attach the bike-mounted mobile device 608 to either the handlebars of the bicycle 612 or at some other location.

It will be appreciated that the bicycle 612 itself, and the body of the cyclist 602 may exhibit different motion patterns during a cycling trip. For example, the body of the cyclist 602 may exhibit more back-and-forth motion relative to the motion of the bicycle 612. On the other hand, the bicycle 612 may exhibit more side-to-side motion. Further, if the body-mounted mobile device 606 is carried in the pocket of pants of the cyclist 602, the motion pattern of the body-mounted mobile device 606 may be very different from that of the bike-mounted mobile device 608. Specifically, as the thigh of the cyclist 602 moves up and down, a certain frequency of up-and-down motion is experienced by the body-mounted mobile device 606.

The cargo 610 may be contained within packaging having a radio-frequency identifier tag 614 and an inertial motion unit (IMU) 616 embedded therein or attached thereto. In other examples, the radio-frequency identifier tag 614 and inertial motion unit (IMU) 616 may otherwise be associated with or attached to the cargo 610. The radio-frequency identifier tag 614 operatively allows the cargo 610 to be identified and tracked electronically, and the inertial motion unit (IMU) 616 allows independent motion pattern data to be captured for the cargo 610. A transmitter (e.g., a Bluetooth transmitter) operates to allow either the body-mounted mobile device 606 or the bike-mounted mobile device 608 to receive motion pattern data, related to the cargo 610, generated by the inertial motion unit (IMU) 616.

Further, the bicycle 612 may have many sensors (e.g., operating according to the Bluetooth or ANT+ transmission protocols) mounted thereto. For example, a cadence and wheel rotation sensor 618 is shown to be coupled to the frame of the bicycle 612 and allows the pedal cadence of the cyclist 602 to be measured, in addition to the rotational speed of the rear wheel of the bicycle 612. Any one of several other commercially available GPS, speed sensors, and location sensors may also be attached to the frame of the bicycle 612.

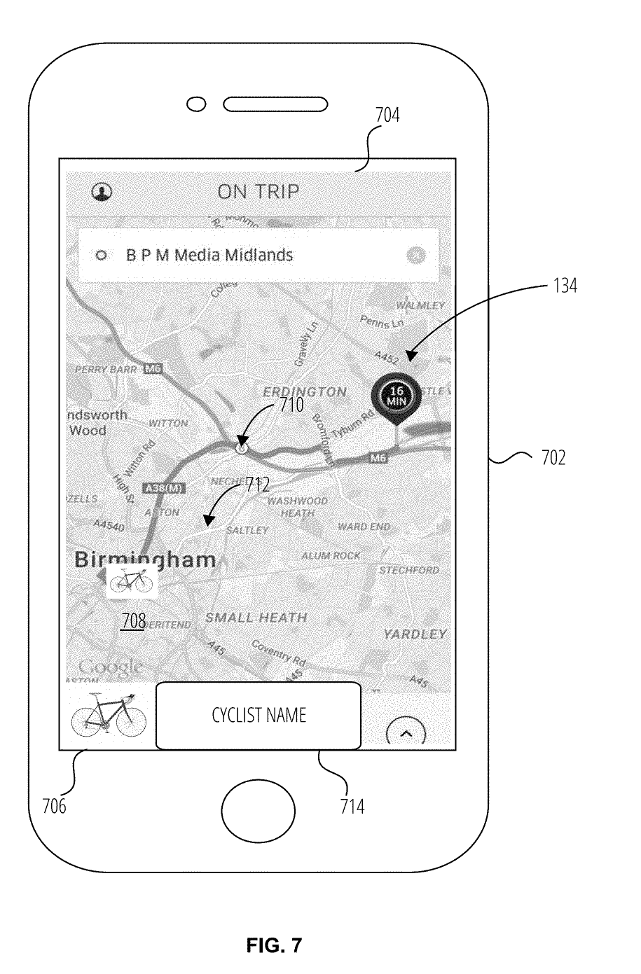

FIG. 7 is a diagrammatic representation of a mobile device 702 presenting route data, according to some example embodiments for a cyclist, the route data including a shortcut segment and an excluded or avoided route segment.

In one embodiment, the mobile device 702 is the provider device 108 that is executing the provider application 110, which in turn, presents a routing user interface 704. The routing user interface 704 displays route data 132 in a graphical form as a highlighted route overlaid on a map. The highlighted route includes a shortcut 710 (e.g., a tunnel), as well as an avoided route 712 (e.g., a route composed of avoided route segments that were specifically excluded from the route data 132). The identification of the shortcut 710, as well as the avoided route 712, by a routing engine 118, will be described in further detail below with reference to flowcharts.

The routing user interface 704 also displays a bicycle icon 706 representative of a specific bicycle that a cyclist may be riding, a cyclist name 714, and ETA data 134.

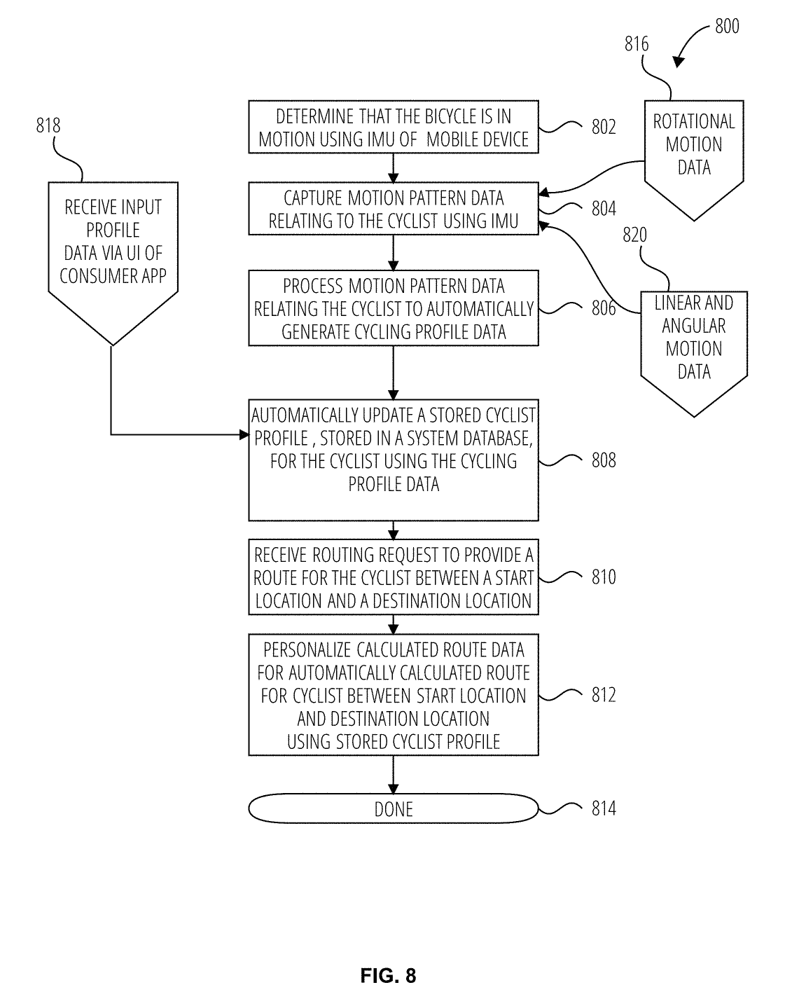

FIG. 8 is a flowchart illustrating a routine 800, according to some example embodiments, to personalize route data for a cyclist riding a bicycle. In one example embodiment, a cyclist 602 may be a bike courier who is interacting with the service delivery system 102 to fulfill a service request. Specifically, the bike courier may be operating as a service provider to deliver a package or other cargo from a destination location (e.g., a restaurant that has prepared a takeout meal) to a destination location (e.g., an apartment of a consumer who has ordered the takeout meal from the restaurant). While certain embodiments are discussed within the context of a bike courier, it will be appreciated that embodiments are not so limited and may find broader application for the routing of transport (e.g., for a cyclist or motorbike rider embarking on a recreational ride).

In one example, the routine 800 commences with a determination, at block 802, that the bicycle 612 is in motion. This determination by the processor 406 may be performed based on input received from the inertial motion unit (IMU) 404 and/or the position unit 410.

At block 804, the inertial motion unit (IMU) 404 then begins capture of the motion pattern data 408, which is communicated to the processor 502. As indicated, the motion pattern data 408 may include rotational motion data 816 (e.g., as captured by a gyroscope sensor that forms part of the inertial motion unit (IMU) 404) and/or linear and angular motion data 820 (e.g., as captured by an accelerometer and/or an angular rate sensor that forms part of the inertial motion unit (IMU) 404). The linear and angular motion data 820, as captured by an accelerometer, may furthermore include side-to-side motion data and back-and-forth motion data. In some embodiments, where the mobile device does not include an inertial motion unit (IMU) 404, the capture of the motion pattern data 408 may be performed by an accelerometer and/or gyroscope of the mobile device, and then communicated to the processor 502.

At block 806, the processor 502 automatically processes the motion pattern data 408 relating to the cyclist to generate cycling profile data for the cyclist 602. In one example embodiment, the cycling profile data includes the pedal cadence data 414, which is in turn derived from the frequency data 412, which is in turn derived from the motion pattern data 408. The processor 502, at block 806, may perform a first determination that the mobile device housing the inertial motion unit (IMU) 404 is operationally mounted on-bike and, responsive to the first determination, process the motion pattern data according to a first algorithm to derive the estimated pedal cadence data 414. The processor 502, at block 806, may also perform a second determination that the mobile device is operationally located on a body of the cyclist at a first body location and, responsive to the second determination, process the motion pattern data according to a second algorithm to drive the estimated pedal cadence data 414

More specifically, the processor 502 may at block 806 derive simple motion patterns in a specific target frequency range (e.g. 20 Hz-120 Hz). To this end, the processor 502 operatively process motion in different axes, such as front-and-back motion as well as side-to-side motion. In some embodiments, the processor 502 may analyze motion pattern data 408 either from a fused IMU (e.g., inertial motion unit (IMU) 404) to determine whether cadence is determinable in order to generate the pedal cadence data 414. The processor 502 may also analyze motion pattern data 408 received from an accelerometer (e.g. subtle side-to-side and front-to-back motions) and/or a gyroscope (side-to-side motion) the mobile device.

The processor 502 may also determine that the mobile device is operationally mounted on-bike based on the nature of the motion pattern data 408. In order to perform cadence detection (in order to generate the pedal cadence data 414) where the mobile device is mounted on-bike, the processor 502 may deploy at the first algorithm to process the motion pattern data 408 in two axes. Specifically, side-to-side motion may be observable based on the fact that cyclists often rock their bicycles subtly in a side-to-side manner as they pedal. Front-to-back motion may be observable based on an inherent lack of smoothness in peddling power as a cyclist's legs rotate about the pedals. At different angles of the crank, different leg power is often applied by a cyclist, even when the cyclist is clipped into the pedals (which allows full pull, push and kick-scratch motion, rather than just pushing). In order to perform cadence detection where the mobile device is off-bike (e.g., mounted on-body), the processor 502 may deploy the second algorithm to process the motion pattern data 408 differently. Specifically, where the mobile device is leg-mounted, pedometer-style sensing may be deployed. Where the mobile device is an upper-body mounted, and analysis similar to that performed for on-bike detection may be performed.

At block 808, the processor 502 automatically updates a stored cyclist profile, stored in a system database, for the cyclist 602 using the generated cycling profile data. For example, the processor 502 may update a user record 212, which is representative of the stored cyclist profile, within the user database 136 with pedal cadence data 414 specific to the cyclist 602.

In this way, a stored cyclist profile, in the form of the user record 212, can be automatically updated within a database, based on observed cycling behavior, and specifically based on captured motion pattern data 408. The updated stored cyclist profile is then available for use in responding to routing requests related to the cyclist 602.

FIG. 8 also shows that the routine 800 can include receipt, at block 818, of input profile data via the user interface of the provider application 110. For example, the cyclist 602 may manually provide input profile data (e.g., a minimum preferred cadence and or other routing preferences).

As an alternative to minimum preferred cadence, the cyclist 602 can directly input a maximum grade via the provider application 110. The routing engine 118 then calculates a minimum cadence based on a minimum gear length and the maximum grade.

The cyclist 602 can also enter other data such as a maximum speed limit (e.g., so that the routing engine 118 can avoid roads carrying car traffic exceeding a speed limit that is comfortable for the cyclist 602), or a maximum relative car speed (e.g., the cyclist 602 may not be averse to faster speed roads if they are downhill, and the cyclist 602 can thus keep up with car traffic). Further, the cyclist 602 may input, via a user interface of the provider application 110, a combined bicycle and human mass (e.g., an unladened total weight). This combined mass is used by the routing engine 118 to assess whether the cyclist 602 can traverse a particular route segment, even when transporting heavy parcels that become significant in relation to unladened total weight.

At block 810, a routing request is received at the service delivery system 102. The routing request is for a route for the cyclist 602 from a starting location, identify by start location data (e.g., a pickup location for a package or take-out meal to be delivered by the cyclist 602) to a destination location, identified by destination location data (e.g., an apartment or workplace of a package recipient or customer who ordered the take-out meal). The start location data and destination location data may be place names or GPS coordinates. The routing request is received by the routing engine 118 from the matching system 124 based on the matching system 124 having matched a particular consumer request with a particular provider (e.g., the cyclist 602). For example, the matching system 124 may determine that the cyclist 602 is within a specific geographic proximity of the start location. Having then presented the service request to the cyclist 602 via the provider application 110, and having received acceptance from the cyclist 602 of the service request, the matching system 124 issues a routing request to the routing engine 118 for a personalized route for the cyclist 602 from the start application to the destination location.

At block 812, the routing engine 118, responsive to receipt of the routing request from the matching system 124, accesses the stored cyclist profile (e.g., the user record 212 for the cyclist 602) within a system database (e.g., the user database 136). Having then accessed the user record 212 and retrieved the contents of this record, the routing engine 118 proceeds to personalize route data 132. An automatically calculated route for the cyclist 602 between the start location and the destination location is presented to the cyclist 602 via a user interface of the provider application 110 (e.g., as shown in FIG. 7)

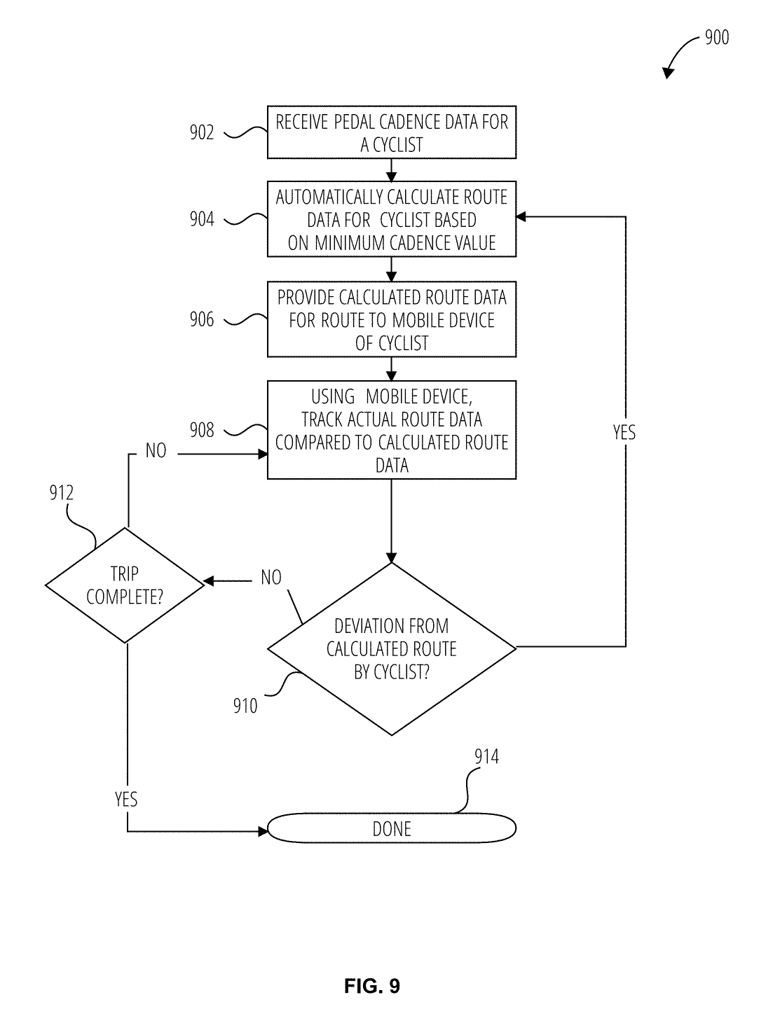

While the personalization and optimization of the route data 132 at block 812 may take into account other information within a stored cyclist profile, further details regarding how, in one example, a minimum cadence value forming part of the pedal cadence variable 218 may be used for this personalization will now be described with reference to FIG. 9.

FIG. 9 is a flowchart illustrating a routine 900, according to some example embodiments, to generate bicycle routing data. The routine 900 commences at block 902 with receiving (e.g., retrieval) of a pedal cadence variable 218 for the cyclist 602 from an appropriate user record 212 stored within the user database 136 by the routing engine 118. At block 904, the routing engine 118, and more specifically the cadence calculation module 508 that forms part of the routing engine 118, derives a minimum pedal cadence variable 218. The deriving of the pedal cadence variable 218 may include an analysis of historical cadence data for the cyclist 602 (e.g., as stored within the user record 212 for the particular cyclist 602 or in the history database 128) and the calculation of a minimum cadence of value (or range for a minimum cadence values). In an example embodiment, the routing engine 118 calculates an optimal cadence range for the cyclist 602 (e.g., a range between 50-90 RPMs).

In a yet further embodiment, the cyclist 602, using an interface of the provider application 110, may manually provide a minimum cadence value, optimal cadence value, or an optimal range of cadence values, which are stored as part of the pedal cadence variable 218 within the user database 136. This information may accordingly be retrieved at block 902.

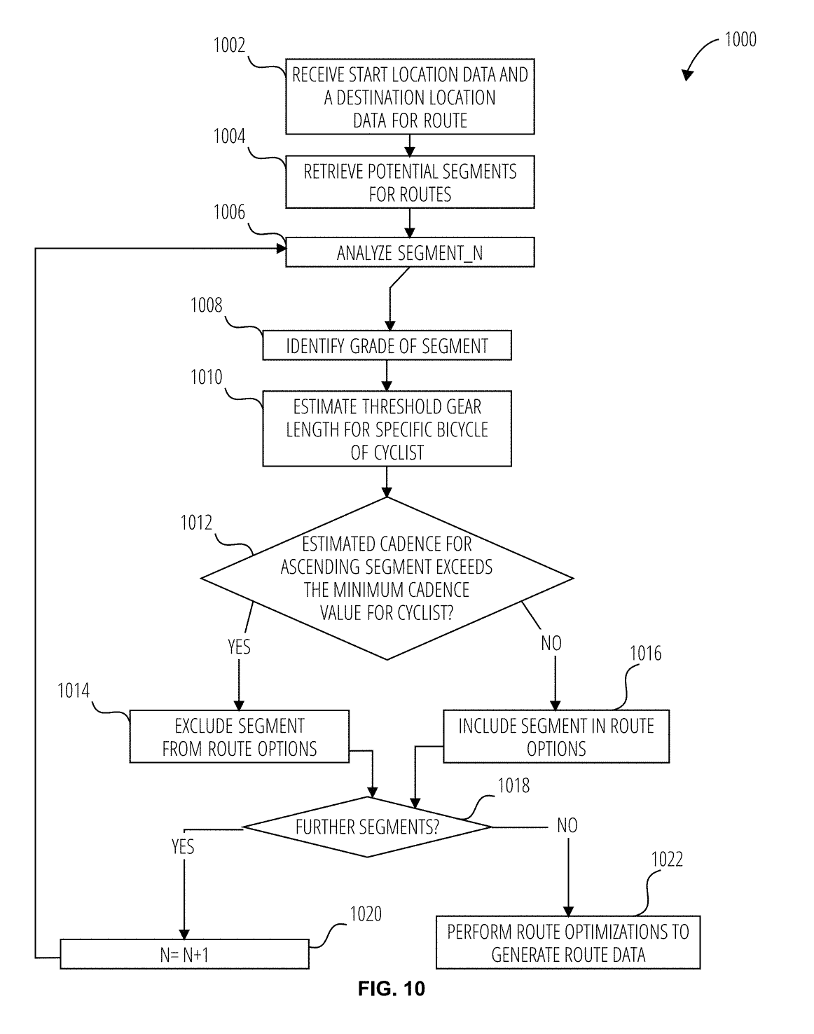

At block 904, the routing engine 118 calculates routing data for the cyclist 602, based on the retrieved minimum or optimum pedal cadence variable 218, or range of optimum cadence values. Further details regarding the specifics of the calculation of the routing data are discussed below with reference to FIG. 10.

At block 906, the route data 132 is provided by the routing engine 118, via the provider interface 116, to the provider application 110 executing on the provider device 108. The provider application 110, then, via an appropriate user interface, presents the route data 132 to a provider user of the provider device 108. To this end, FIG. 7 shows an example provider device 108, in the form of the mobile device 702, which is executing the example provider application 110, which in turn presents the routing user interface 704 on which the route data 132 is graphically represented by a highlighted line or path overlaid on a map.

At block 908, the service delivery system 102 operatively tracks actual route data on the provider device 108 relative to the route data 132. The tracking system 130 receives real-time and continuous location updates (e.g., in the form of messages including location data) from the provider application 110 operating on the provider device 108. These location messages are provided by the provider application 110 via the provider interface 116 to the tracking system 130.

In this way, the tracking system 130, at decision block 910, determines whether the cyclist 602 has deviated from the calculated route. If so, and responsive to a determination that the cyclist 602 has in fact deviated from the calculated route, the routine 900 loops back to block 904 to perform a reroute operation and automatically recalculates and generates fresh route data for a new route. On the other hand, if no deviation from the calculated route is detected at decision block 910, the routine 900 proceeds to decision block 912, where the tracking system 130 determines whether the trip is complete (e.g., whether a current location of the cyclist 602 correspondence with a destination location for the trip). If so, the routine 900 completes at block 914. On the other hand, if it is determined, at decision block 912, that the trip is not complete, the routine 900 loops back to block 908.

FIG. 10 provides further details regarding the automatic calculation of route data at block 904 within the routine 900, according to some example embodiments. Specifically, as noted with respect to FIG. 9, the routing engine 118 calculates route data for the cyclist 602, based on a retrieved minimum (or optimum) pedal cadence variable 218, or a range of minimum (or optimum cadence values). The calculating of the route data 132 by a routine 1000 commences, at block 1002, with retrieval of start location data identifying a start location for a trip and retrieval of destination location data identifying a destination location for the trip.

At block 1004, the routing engine 118 uses this location data to perform a lookup in the map database 120 to identify multiple segments for potential routes between the start and destination locations for a specific trip. As noted with reference to FIG. 2, the map database 120 stores multiple segment records 202, each segment having a respective segment record 204. Each segment record 204, in addition to other information, stores grade information 228 for the relevant segment, the grade information 228 identifying at least a maximum grade of the segment (e.g., expressed in degrees). 100111j Having retrieved the potential segments at block 1004, the routing engine 118 then enters an analysis loop to assess each of the potential segments (e.g., for cost allocation or for specific inclusion or exclusion) within a calculated route. Specifically, at block 1008, the routing engine 118 identifies a grade for the relevant segment (e.g., from the grade information 228). At block 1010, the routing engine 118 retrieves estimates for a threshold (e.g., minimum or maximum) gear length for a specific bicycle of a cyclist. An estimation of the threshold gear length, which may be performed at block 1010, may be performed in real-time during the routing operation, or may alternatively be a pre-calculated and stored within the user record 212 for the specific cyclist (e.g., as the gear length variable 232 associated with the bicycle identifier 230 in the user record 212). The estimating of the threshold gear length for the specific bicycle of the cyclist may include retrieving historical speed and cadence data for the cyclist on a specific bicycle (e.g., generated on a cycling exercise or trip on the specific bicycle), and then calculating the estimated threshold gear length for that specific bicycle using this speed and cadence data.

Estimating of the threshold gear lengths can be performed in several ways by a processor 502. For example, after determining cadence (by the cadence calculation module 508), the processor 502 examines data reflecting the distance traveled for each unit of time (speed), and the cadence in rotations per second, and the speed in meters per second. A gear length is calculated by solving for meters per rotation. For example, (meters/sec)/(rotation/sec)=meters/rotation=speed/cadence.

Alternatively, the cyclist can determine a spot on the ground for each time the pedal crosses a certain point on the cycle, and the distance between two such spots can be measured.

Finally, any gear combination in teeth for front and rear and the circumference of the driver tire with full weight on it can be used to estimate a gear length. The gear length is circumference times front tooth count divided by rear tooth count.

In other embodiments, gear length information for a specific bicycle may be manually inputted by a cyclist using the provider application 110 and stored as the gear length variable 232 associated with the bicycle identifier 230 within the user record 212. In this case, at block 1010, the gear length variable 232 is simply retrieved from the user database 136 by the routing engine 118.

From block 1010, the routine 1000 then proceeds to decision block 1012, where a determination is made, using the grade information 228 retrieved at block 1008 and the gear length information 232 retrieved at block 1010, whether an estimated cadence for traversing (e.g. ascending) the segment being analyzed transgresses (e.g., is less than) a minimum cadence value (e.g., reflected by a pedal cadence variable 218) for the relevant cyclist. To this end, the processor 502 (and more specifically the cadence calculation module 508 and the power calculation module 510) generate a data value akin to a “functional threshold power” for each user, which is termed a “typical cycling power ceiling” (TCPC).

Given a good approximate for the unladen total weight of a cycling unit 600 (e.g., a cyclist, combined with a cargo weight), the processor 502 calculates an “actual total weight.” The weight of a cargo 610 may be stored in association with an identifier of the radio-frequency identifier tag 614 and retrieved from a third party, such as a shipping company or from a database of the service delivery system 102.

Given the grade of each segment (e.g., road segment), the processor 502 calculates how fast the cycling unit 600 can climb on each segment and then computes the amount of at-surface power a cyclist is able to generate.

From grade and a cyclist's speed, the processor 502 determines a rate of climb (e.g., meters (or centimeters) per second). Very fit cyclists and racers often know their unladen rate of climb in “feet per hour” or “meters per hour” depending on their country of origin.

Given their actual total weight of the cycling unit 600, a force in newtons is calculated by the processor 502 (e.g., gravitational acceleration (9.8 meters per second squared) times the mass—so 100 kg becomes 980 newtons). The processor 502 then multiplies the newtons by the rate of climb in meters per second to generate power expressed in watts (e.g., 980 newtons times 0.2 meters per second (720 meters per hour or 2362 feet per hour or 20 cm per second rate of climb) to get 196 watts.)

The processor 502 then calculates an estimated maximum power over an hour's time of consistent cycling by the cyclist. Assuming the cyclists has many hours of cycling time recorded, for example, in the history database 128, the processor uses the average of multiple individual maximums over multiple hours over a block of recent time (e.g., a couple weeks) to estimate the maximum power. A cyclist constantly cycling near their lactate threshold then would have a TCPC that is approximately equal to their FTP.

Once the processor 502 has calculated the estimated maximum power, a maximum rate of climb of the particular total weight for the cycling unit 600 (including the cargo) is calculated by the processor 502. The maximum rate of climb is calculated independently of cadence. The processor 502 then receives the TCPC and an actual total weight (ATW) for a particular trip of the cycling unit 600.

The processor 502 then converts the ATW of the cycling unit 600 to force by multiplying by acceleration due to gravity (9.8 meters per second squared) For example, assuming 1000 newton's of force and an estimated maximum power of 200 Watts, a rate of climb of 0.2 meters per second is calculated. This factors into time estimates for how fast the cycling unit 600 can complete each segment and that adjusts how likely the routing engine 118 is to route the cycling unit 600 by the nature of a routing algorithm that optimizes for speed.

The processor 502 then processes cadence to determine if the cycling unit 600 can even traverse a particular segment comfortably without the cyclist getting off and walking (which is something the routing engine 118 may consider a possible “shortcut” in other parts of the method). Specifically, the processor 502 multiplies a minimum gear length by 60 rotations per minute (1 rotation per second) to determine a minimum speed at an efficient minimum cadence. This minimum cadence may also be configurable by the cyclist if they want to go lower or higher for some reason. For example, endurance cyclists may want to push minimum cadence. up to 70 or 80 RPM to be able to go all day for maximum efficiency. Assuming a minimum gear length is 2 meters, then 2 meters per second is a good minimum speed, 7.2 KPH or 4.5 MPH.

The processor 502 can now determine a cadence-limiting rate of climb independent of power (as calculated above). Given that, in the provided example, a cycling unit 600 can climb at 0.2 meters per second at a minimum speed is 2 meters per second, the processor 502 operatively divides the rate of climb by the minimum speed to generate a maximum grade. In this example, the maximum grade would be calculated to be 0.1, or 10%. Above a 10% grade, the cadence of the cycling unit 600 would drop to less than 60 rpms and the cyclists would consider avoiding the relevant segment or switching to walking.

In the event it is determined at decision block 1012 that the estimated cadence for ascending the segment under analysis is less than the minimum cadence value (e.g., a pedal cadence variable 218), the cost of the relevant segment, in a cost model used by the routing engine 118, is adjusted (e.g., increased) at block 1014. On the other hand, if the estimated cadence for ascending the segment is not determined to be less than the minimum cadence value, the cost of the relevant segment, in a cost model used by the routing engine 118, is adjusted (e.g., decreased) at block 1016. The adjusting of the cost of the segment may result in the segment being included or excluded from the route data 132 generated by the routing engine 118. In an alternative embodiment, as opposed to adjusting a cost for the relevant segment, the segment may simply be excluded from the routing data 132 when the minimum cadence value is determined to be less than the minimum cadence value.

The routine 1000, at decision block 1018, then determines whether further segments, of the segments retrieved at block 1004, required analysis. If so, a count value is incremented at block 1002, and the routine 1000 then loops back to block 1006 to begin an analysis sequence for the next segment. On the other hand, if no further segments require analysis, the routine 1000 proceeds to block 1022, where the routing engine 118 performs route optimizations and calculations to generate the route data 132, using segments that were not excluded by the routine 1000. The performance of further route optimizations that are performed to generate the route data 132 at block 1022 may include any one of the routing algorithms discussed above.

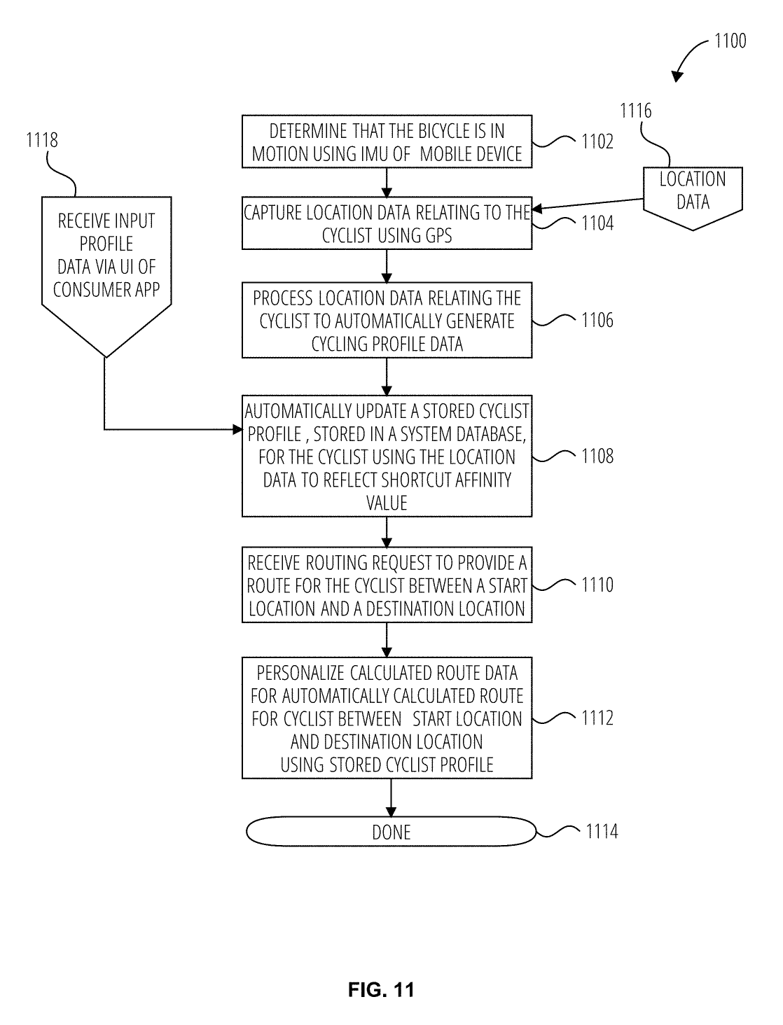

FIG. 11 is a flowchart illustrating a routine 1100, according to some example embodiments, to personalize route data for a cyclist riding a bicycle. As with the embodiment described with reference to FIG. 8, a cyclist 602 may be a bike courier who is interacting with the service delivery system 102 to fulfill a service request.

The routine 1100 commences at block 1102 with a determination by the processor 406 that the bicycle 612 is in motion. This determination is performed based on input received from the inertial motion unit (IMU) 404 and/or the position unit 410.

At block 1104, the position unit 410 (e.g., a GPS) begins capture of the location data 1116, which is communicated to the processor 502.

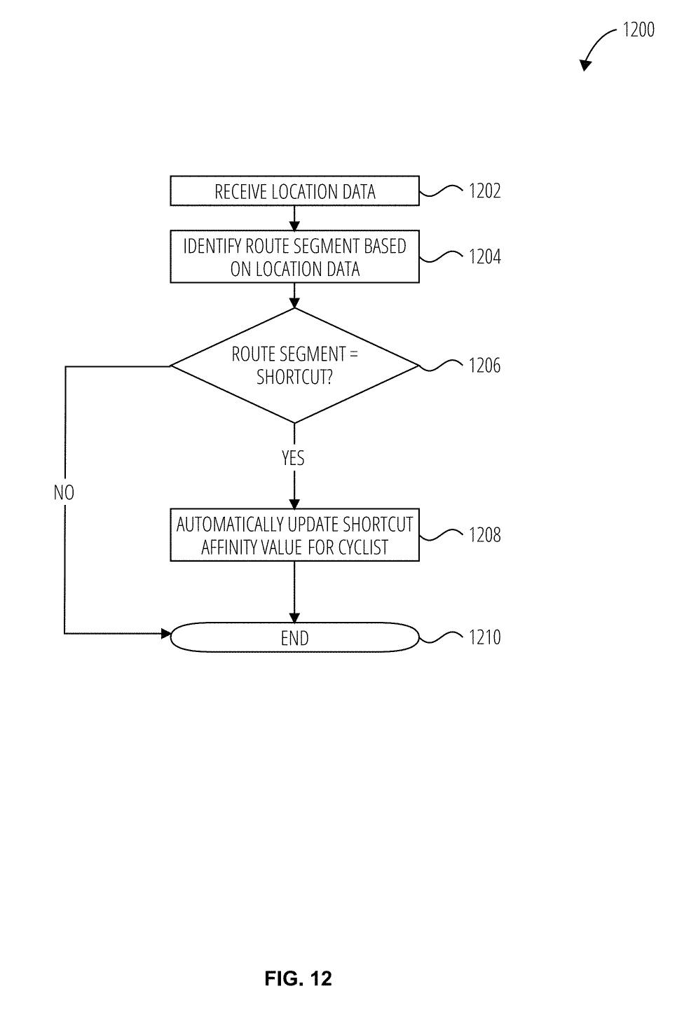

At block 1106, a processor 502 automatically generates cycling profile data for the cyclist 602. In one example embodiment, the cycling profile data includes the location data 1116. The location data 1116 may identify a segment of a trip as a shortcut route segment based on the shortcut segment identifier 208 stored in the segment record 204 or as a transit route segment based on a transit segment identifier 234 stored in the segment record 204 for the relevant segment. Further details regarding the operations performed at block 1106 are described below with reference to FIG. 12.

At block 1108, the processor 502 operates to automatically update a stored cyclist profile, stored in a system database, for the cyclist 602 using the generated cycling profile data. For example, the processor 502 may update a user record 212, which is representative of the stored cyclist profile, within the user database 136 with pedal cadence data 414 specific to the cyclist 602.

In this way, a stored cyclist profile, in the form of a user record 212, can be automatically updated within a database, based on recorded historical cycling behavior. The updated stored cyclist profile is then available for use in responding to routing requests related to the cyclist 602.

FIG. 11 also shows that the routine 1100 includes receipt, at block 1118, of input profile data via the user interface of the consumer application 106. For example, the cyclist 602 may manually provide input profile data (e.g., a minimum preferred cadence and or other routing preferences).

At block 1110, a routing request is received at the service delivery system 102. The routing request is for a route for the cyclist 602 from a starting location, identify by start location data (e.g., a pickup location for a package or take-out meal to be delivered by the cyclist 602) to a destination location, identified by destination location data (e.g., an apartment or workplace of a package recipient or customer who ordered the take-out meal). The start location data and destination location data may be place names or GPS coordinates. The routing request is received by the routing engine 118 from the matching system 124 based on the matching system 124 having matched a particular consumer request with a particular provider (e.g., the cyclist 602). For example, the matching system 124 may determine that the cyclist 602 is within a specific geographic proximity of the start location. Having then presented the service request to the cyclist 602 via the provider application 110, and having received acceptance from the cyclist 602 of the service request, the matching system 124 may issue a routing request to the routing engine 118 for a personalized and optimized route for the cyclist 602 from the start application to the destination location.

At block 1112, the routing engine 118, responsive to receipt of the routing request from the matching system 124, accesses the stored cyclist profile (e.g., the user record 212 for the cyclist 602) within a system database (e.g., the user database 136). Having then accessed the user record 212 and retrieved the contents of this record, the routing engine 118 proceeds to personalize route data 132. Thereafter, an automatically calculated route for the cyclist 602 between the start location and the destination location is presented to the cyclist 602 via a user interface of the provider application 110.

FIG. 12 is a flowchart illustrating a subroutine 1200, according to some example embodiments, which may be implemented at block 1106 and block 1108 of the routine 1100, to process location data and update a stored cyclist profile. The subroutine 1200 commences at block 1202, with receipt (e.g., retrieval) of location data 1116 by the routing engine 118. The location data may be a series of GPS coordinates (e.g., a GPS route trace), but may also be one or more place names. If place names are received, the routing engine 118 performs a lookup in the place database 126 to retrieve a GPS coordinates for the place names.

Using the GPS coordinates, at block 1204, the routing engine 118 identifies one or more route segments using the location data. Specifically, the routing engine 118 performs a lookup, using GPS coordinates, within the map database 120 to identify segment records 202 corresponding to the relevant GPS coordinates (e.g., by performing a matching operation between the GPS coordinates including the location data and GPS coordinates for a specific segment record 204). Having then identified a set of segment records 202, the routing engine 118 determines whether any one or more of the segment records 202 have been flagged as a shortcut segment by examining the shortcut segment identifier 208 for each of the segment records 202. In the case where a specific segment record 204 is identified as a shortcut at decision block 1206, the routing engine 118 automatically updates a shortcut affinity variable 216 for the relevant cyclist within a corresponding user record 212 of the user database 136 (e.g., by setting the shortcut affinity variable 216 to a “YES” value, or otherwise reducing the cost of the segment (e.g., by increasing a value of the shortcut affinity variable 216). In this way, the “affinity” (e.g., propensity or ability based on historical data) for a particular cyclist to use shortcuts on a cycling trip may be automatically recorded for later use in automatic routing. In one example embodiment, the shortcut affinity variable 216 may be a binary value (e.g. a 1 or a 0, or a YES or a NO). In this embodiment, the shortcut affinity variable 216 may be toggled between the binary values, based on the last observed use of a “shortcut” segment by the cyclist.

In another embodiment, the shortcut affinity variable 216 may have a range of values indicative of a cost associated with the segment in terms of a cost model 138, and the value may be either increased or decreased by the routing engine 118, according to analyzed past cycling trips of the relevant cyclist. For example, responsive to the identification of a shortcut segment that a cyclist has used in the past cycling trip, the routing engine 118 may increase a value (e.g., thereby decreasing the cost) of the shortcut affinity variable 216. Alternatively, where a cyclist is observed or recorded to have actively avoided a shortcut in favor of another segment in historical trip data (e.g., GPS trace data), the routing engine 118 may operatively decrease the value the shortcut affinity variable 216 (e.g., thus increasing the cost of the segment). In this embodiment, the shortcut affinity variable 216 may also be normalized across multiple cyclists. This normalization may be based on certain data such as, for example, a total number of segments traversed by a cyclist or the total distance traversed by a cyclist in a given time frame. In this way, the shortcut affinity variable 216 for a cyclist that covers a large distance, and the shortcut affinity variable 216 for a cyclist that covers much less distance, within a given time period, can be normalized.

In one example embodiment, the value for the shortcut affinity variable 216 may float between 0.0 and 1.0. In addition to the shortcut affinity variable 216, a global probability variable is stored for each segment, the value for this variable indicating a general probability that a cyclist will take the shortcut. A further variable, namely a shortcut type probability variable, stores a value that indicates a probability that a particular cyclist will take shortcuts of particular types (e.g., stairs, transit nodes). Further, the routing engine 118 operationally determines a minimum distance or time that is actually saved, on average, for each use of a particular shortcut by comparing it against a route around (or that otherwise circumvents) that shortcut. The minimum distance or time is calculated by computing a route between both sides of the shortcut when the shortcut is disallowed or excluded from traversal. These values are then used at runtime by the routing engine 118 to combine the amount of time or distance saved and the affinities of use, to determine the estimated cost of taking the shortcut with adjustments against their potential undesirability.

Returning to FIG. 12, if a particular route segment is assessed at decision block 1206 not to be a shortcut route segment, the analysis for that particular route segment terminates at block 1110.

The personalization of the route data 132 for the cyclist at block 1112 of routine 1100 will, according to some embodiments, reference the shortcut affinity variable 216 for a specific cyclist as stored within the user record 212. In some example embodiments, the shortcut affinity variable 216 is a binary value, and the routing engine 118 may exclude one or more segments from a calculated route, based on a binary value of the shortcut affinity variable 216.

In a further example embodiment, in which the shortcut affinity variable 216 has a range value (e.g., the above described increased/decreased value, which is normalized across multiple users), the personalization of the route data 132 at block 1112 includes incorporating the value of the shortcut affinity variable 216 as a cost factor into a cost calculation performed by the routing engine 118 (e.g., using the cost model 138) with a higher value (indicating a higher affinity) having a lower cost.

In some embodiments, the routing engine 118 may assess whether the shortcut affinity variable 216 for a relevant cyclist transgresses (e.g., exceeds) a determined minimum threshold value. If so, the routing engine 118 automatically and selectively includes shortcut segments (identified as such by the shortcut segment identifier 208) within the route data 132. Alternatively, based on a determination that the shortcut affinity variable 216 for a particular cyclist does not transgress the determined threshold, shortcut segments may automatically and selectively be excluded from the route data 132 for the particular cyclist.

In further embodiments, the automatic calculation of the route data 132 at block 1112 may take other, lower resolution, data into account when selectively including or excluding a shortcut segment from the route data 132. As shown in FIG. 2, a particular shortcut segment identifier 208 may have other attributes associated therewith, namely the bike weight attribute 222, the bike tire attribute 224, and/or the stair attribute 226. Further, a particular shortcut segment identifier 208 may be flagged as explicitly approved or prohibited from inclusion within route data 132 by an approved/prohibited identifier 236.

With respect to a bike weight attribute 222, regardless of any automatic assessments performed with respect to shortcut affinity variable 216, where it is automatically determined that the weight of a bicycle, as reflected by the value of a weight variable 240 associated with a bicycle identifier 230, transgresses a threshold value associated with the shortcut segment identifier 208, the relevant segment is selectively excluded from the route data 132 or the cost of the relevant segment may be increased in a cost model. A transgression of the threshold value by the value of the weight variable 240 indicates that the weight of the specific bicycle of the cyclist may be too heavy for that bicycle to be practically used on the relevant shortcut segment. For example, where the relevant bicycle is an electrically powered bicycle, and it is determined that the relevant shortcut segment may require the cyclist to carry the bicycle, then such a segment may be automatically and selectively excluded from the route data 132 in this manner.

Similarly, with respect to the bike tire attribute 224, a value for a tire variable 242 indicates a tire width for the specific bicycle. The specified tire width has a threshold value as specified by the bike tire attribute 224 for the relevant shortcut segment. For example, where the shortcut segment is a dirt road that requires a certain minimum tire width, cost of the relevant shortcut segment will be increased or the segment may be automatically and selectively be excluded from the route data 132 where the tire width for the bicycle, indicated by a value of the tire variable 242, is less than a minimum tire value as specified by the bike tire attribute 224.

Turning to the stair attribute 226, this may have a binary value indicating whether the shortcut segment includes stair climbing or not. In this example, a stair affinity variable 244, associated with the shortcut affinity variable 216 for the particular cyclist, may record an “affinity” (e.g., an ability, propensity or expressed permission) by the cyclist to include shortcut segments in personalized route data 132. The stair affinity variable 244 may be automatically updated by the routing engine 118, based on the observed behavior on past trips (e.g., using reroute or GPS trace data). Additionally, a cyclist may set a value for the stair affinity variable 244 to “NO,” where the cyclist specifically does not want to have any shortcut segments having stairs included in their route data 132. This may be the case where the cyclist is unable to carry a bicycle up or downstairs for any one of several reasons.

The automatic updating and supplementing of cyclist profile information has been described above with reference to FIG. 11, according to example embodiments, using location data (e.g., historical ride data in the form of GPS trace data and reroute data from historical regarding operations performed by the routing engine 118). In a similar way, segment information, stored in segment records 202 within the map database 120, may also be automatically updated and supplemented. For example, by an automated analysis (e.g., using machine learning) of reroute and GPS trace data (as examples of location data), the records for certain segments (or other data types) within the map database 120 can automatically be updated and supplemented. For example, a new segment record 204 may be automatically created within the map database 120 based on an observation that cyclists are taking “shortcuts” that were previously unknown and accordingly for which segment records 202 do not exist within the map database 120. Such a “shortcut” segment record 204 may be flagged as such by the setting of an appropriate value for the shortcut segment identifier 208.

Similarly, following the instantiation of the segment record 204 of a newly observed “shortcut” segment, an assessment may be performed to determine whether the relevant segment is, in fact, safe for bicycles, or has any explicit, signed, or clear prohibitions for bicycles. Responsive to a determination that the particular segment is not safe for bicycles, or has a prohibition on bicycles, an appropriate value may be attributed to the approved/prohibited identifier 236 to flag the relevant segment as being either approved or prohibited for future inclusion within route data 132 for cyclists.

Additionally, an analysis of historical cycle trip data (as an example of location data) may be used to identify certain segments (e.g., roads or otherwise) that have historically been avoided by cyclists. If a significant number of cyclists are observed to avoid or bypass a particular segment and, for example, take a parallel route (even if slower), the routing engine 118 may flag such as segment as one to be excluded from, or downgraded in, the future generation of the route data 132 (e.g., by increasing a cost attributed to the segment in a cost model used by the routing engine 118). This flagging includes attributing an appropriate value to the bicycle avoidance identifier 210 of the relevant segment record 204. The value of the bicycle avoidance identifier 210 may be considered as a factor in a cost model used by the routing engine 118 automatically to generate route data 132.

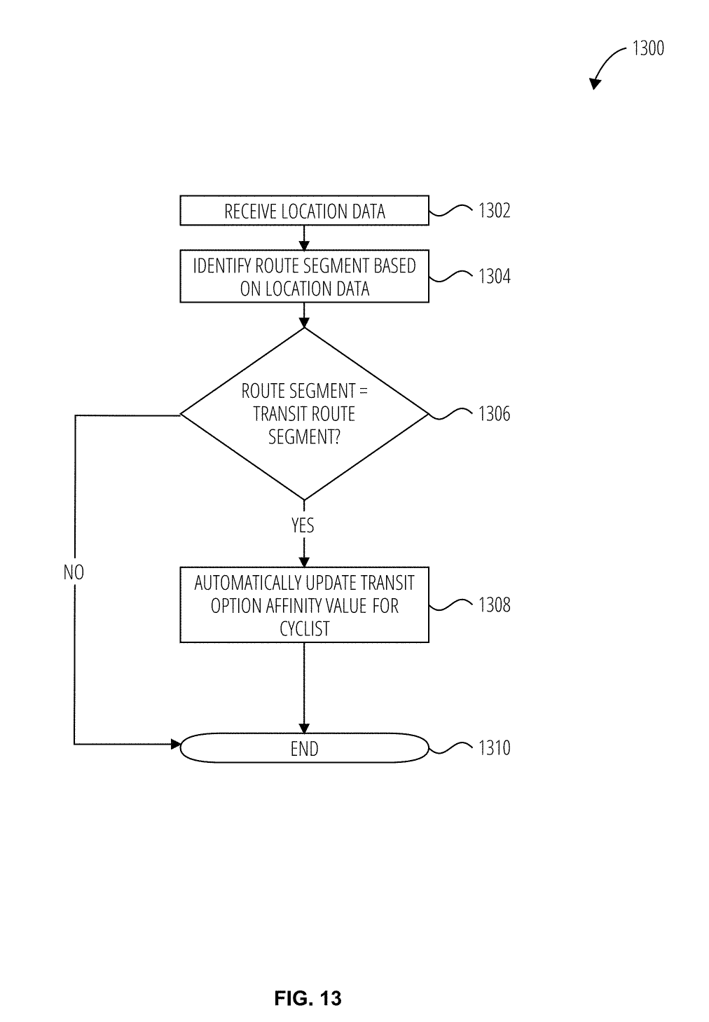

FIG. 13 is a flowchart illustrating a subroutine 1300, according to some example embodiments, which may be implemented at block 1106 and block 1108 of the routine 1100, to process location data and update a stored cyclist profile. The subroutine 1300 commences at block 1302, with receipt (e.g., retrieval) of location data 1116 by the routing engine 118. The location data may be a series of GPS coordinates, but may also be one or more place names. If place names are received, the routing engine 118 performs a lookup in the place database 126 to retrieve a GPS coordinates for the place names.

Using the GPS coordinates, at block 1304, the routing engine 118 identifies one or more route segments using the location data. Specifically, the routing engine 118 performs a lookup, using GPS coordinates, within the map database 120 to identify segment records 202 corresponding to the relevant GPS coordinates (e.g., by performing a matching operation between the GPS coordinates including the location data and GPS coordinates for a specific segment record 204). Having then identified a set of segment records 202, the routing engine 118 determines whether any one or more of the segment records 202 have been flagged as a transit route segments by examining the transit segment identifier 234 for each of the segment records 202. In the case where a specific segment record 204 is identified as a transit route at decision block 1306, the routing engine 118 automatically updates the transit route affinity variable 246 for the relevant cyclist within a corresponding user record 212 of the user database 136 (e.g., by setting the transit route affinity variable 246 to a “YES” value, or otherwise incrementing a value for the transit route affinity variable 246). In this way, the “affinity” (e.g., propensity or ability based on historical data) for a particular cyclist to use transit routes on a cycling trip may be automatically recorded for later use in automatic routing. In one example embodiment, the transit route affinity variable 246 may have a binary value (e.g. a 1 or a 0, or a YES, or a NO). In this embodiment, the transit route affinity variable 246 may be toggled between the binary values, based on the last observed use of a “transit route” segment by the cyclist. In another embodiment, the transit route affinity variable 246 may have a range of values and may be either incremented or decremented by the routing engine 118, according to analyzed past cycling trip data (e.g., GPS trace data) of the relevant cyclist. In this embodiment, the value of the transit route affinity variable 246 may be used in terms of the cost model 138 to attribute a cost to the segment when generating the personalized route data 132. For example, based on an observed or previously recorded transit route segment that a cyclist has used in the past cycling trip, the routing engine 118 may increment a value for the transit route affinity variable 246. Alternatively, where the cyclist is observed to actively avoid a transit route in favor of another segment in historical trip data, the routing engine 118 may operatively decrement a value for the transit route affinity variable 246. In this embodiment, the transit route affinity variable 246 may also be normalized across multiple cyclists. This normalization may be based on certain data such as, for example, the total number of segments traversed by a cyclist or the total distance traversed by a cyclist in a given time frame.

Returning to FIG. 13, if a particular route segment is assessed at decision block 1306 not to be a transit route segment, the analysis for that particular route segment terminates at block 1210.

The personalization of the route data 132 for the cyclist at block 1112 of routine 1100 will, according to some embodiments, reference the transit route affinity variable 246 for a specific cyclist as stored within the user record 212. In example embodiments in which the transit route affinity variable 246 has a binary value, the routing engine 118 may exclude one or more segments from a calculated route, when calculating the personalized route data at block 1012, based on a binary value of the transit route affinity variable 246.

In a further example embodiment, in which the transit route affinity variable 246 has a range value (e.g., the above described incremented/decremented value, which is normalized across multiple users), the personalization of the route data 132 at block 1112 includes assessing whether the transit route affinity variable 246 for a relevant cyclist transgresses (e.g., exceeds) a determined minimum threshold value. If so, the routing engine 118 automatically and selectively includes transit segments (identified as such by the transit segment identifier 234 within the route data 132. Alternatively, based on a determination that the transit route affinity variable 246 for a particular cyclist does not transgress the determined threshold, transit route segments may automatically and selectively be excluded from the route data 132 for the particular cyclist. The transgression of the threshold may, in some embodiments, result in an increase or a decrease in cost attributed to the segment when generating the personalized route data 132. The exclusion of the segment from the route data may be achieved by increasing the cost of the relevant segment to a value where it is excluded from the route data 132. Similarly, the inclusion of the segment from the route data may be achieved by decreasing the cost of the relevant segment to a value where it is included the route data 132.

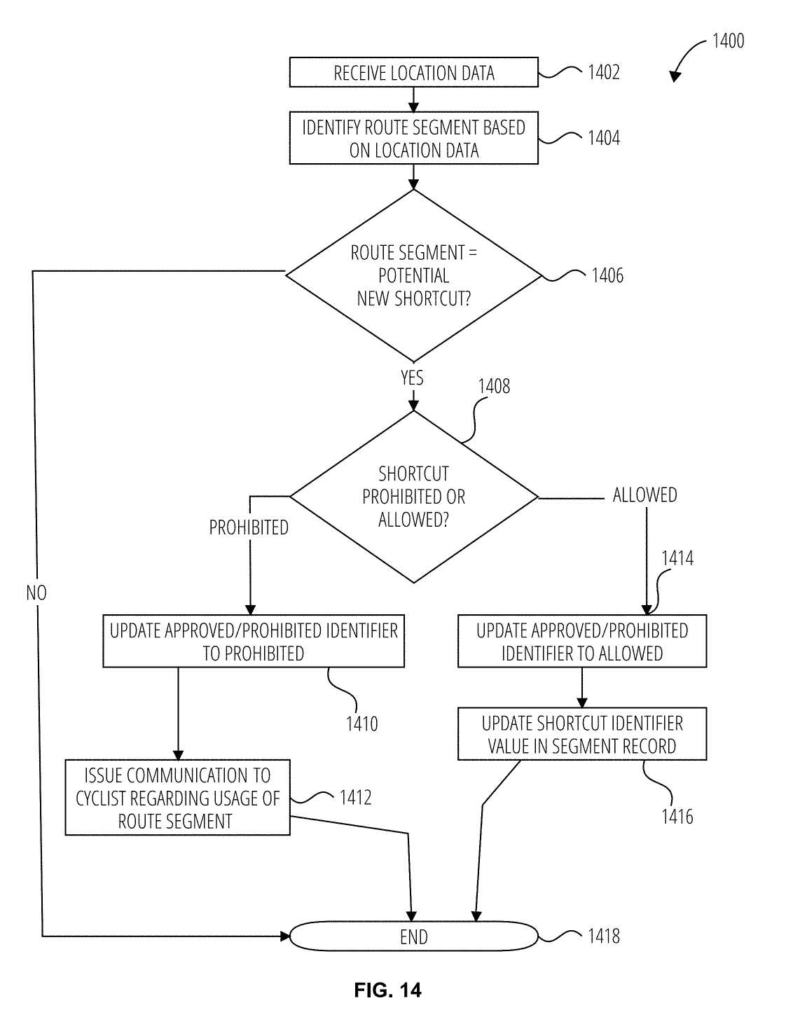

FIG. 14 is a flowchart illustrating a routine 1400, in accordance with one embodiment, to process map segment data relating to shortcuts. The automatic updating and supplementing of cyclist profile information has been described above with reference to FIG. 11, according to example embodiments, using location data (e.g., historical ride data stored in the history database 128 in the form of GPS trace data and reroute data from historical rerouting operations performed by the routing engine 118). In a similar way, segment information, stored in segment records 202 within the map database 120, may also be automatically updated and supplemented by the routine 1400.

Location data is received by the routing engine 118 at block 1402. This location data may be real-time GPS coordinates 238 received from the provider device 108 or historical location data retrieved from the history database 128.

At block 1404, the routing engine 118 automatically identifies (or instantiates) a route segment based on the location data. For example, the routing engine 118 may perform an automated analysis (e.g., using machine learning) of reroute and GPS trace data (as examples of location data stored in the history database 128). Based on this automated analysis, the segment records 202 for certain segments (or other data types or primitives) can automatically be created, updated and supplemented within the map database 120. For example, a new segment record 204 may be automatically created within the map database 120 based on an observation that cyclists are taking “shortcuts” that were previously unknown and accordingly for which segment records 202 did not exist within the map database 120. Such a “shortcut” segment record 204 may be flagged as such by the setting of an appropriate value for the shortcut segment identifier 208. In a further example, an existing segment record 204 may be identified at block 1404 based on the automated analysis of location data.

At decision block 1406, a determination is made regarding whether the newly instantiated or existing segment record 204 relates to a potential new “shortcut” by examination of the shortcut segment identifier 208. If so, an automated assessment may then be performed by the routing engine 118 at decision block 1408 to determine whether the potential shortcut segment is, in fact, safe for bicycles, or has any explicit, signed, or clear prohibitions for bicycles. The assessment at block 1308 includes accessing certain external databases and records to locate express prohibitions, and may also include an automated review of photographic records (e.g., street-level or aerial photographs) that exist in public or private databases. The automated review of the photographic records may assess any one of several attributes and characteristics of the segment, such as the quality of paving or terrain traversed by the segment, the automated identification of obstacles (both natural and man-made) that exist on the segment, and space available on the relevant segment or bicycle traffic (e.g., a lack of space within a tunnel for bicycle traffic). The assessment at decision block 1408 may also include an automated review of historical bicycle and automotive traffic patterns related to the segment. For example, where the potential shortcut segment displays high speed and congested automobile traffic usage (e.g., through a tunnel), this data may weigh against the assessed safety of the segment for bicycle traffic.

Responsive to a determination at decision block 1408 that the particular segment is not safe for bicycles, or has a prohibition on bicycles, an appropriate value may be attributed to the approved/prohibited identifier 236 to flag the relevant segment as being either allowed for (block 1414) or prohibited from (block 1410) future inclusion within the route data 132 for cyclists. Further, at block 1412, the routing engine 118 issues a communication to a cyclist in real-time, responsive to an observed usage of the route segment. This communication includes a warning to the cyclist regarding the safety of the segment, or the express prohibition on bicycle traffic on the segment. This communication may take the form of a notification that is presented on a user interface of the provider application 110 executing on the provider device 108, or may be a text message that is communicated to the service provider.

At block 1416, the routing engine 118 further updates a value for the shortcut segment identifier 208 to flag the relevant segment as a valid shortcut. Routine 1400 then terminates at block 1318.

Additionally, an analysis of historical cycle trip data (as an example of location data) may be used to identify certain segments (e.g., roads or otherwise) that are historically avoided by cyclists. If a significant number of cyclists are observed to avoid or bypass a particular segment and, for example, take a parallel route (even if the slower), the routing engine 118 may flag in such as segment as one to be excluded from or downgraded in the future generation of the route data 132. This flagging includes attributing an appropriate value to the bicycle avoidance identifier 210 of relevant segment record 204. To this end, the value of the bicycle avoidance identifier 210 may be considered as a factor in a cost model 138 used by the routing engine 118 automatically generate route data 132.

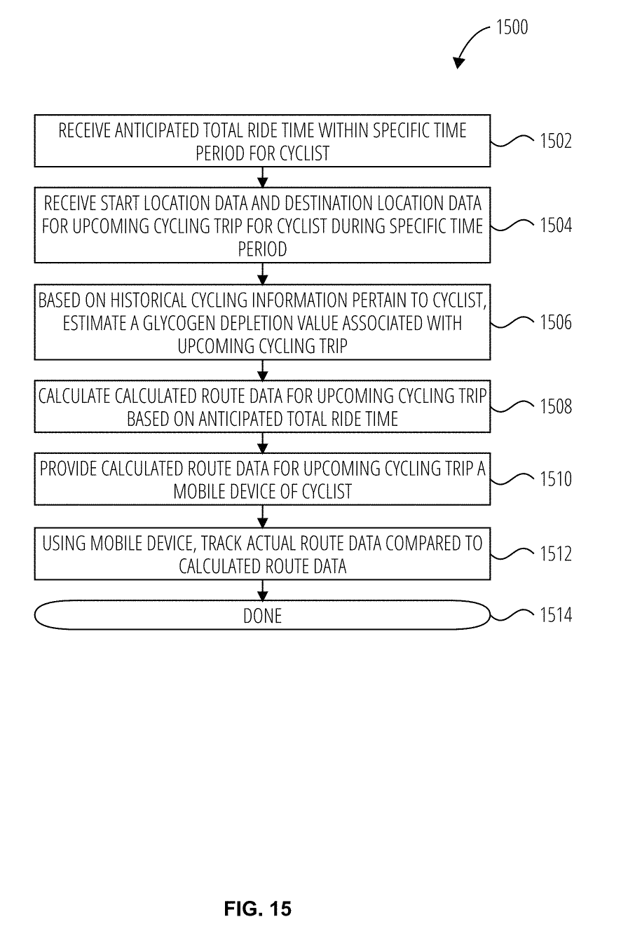

FIG. 15 is a flowchart illustrating a routine 1500, according to some example embodiments, to calculate personalized route data for a cyclist, based on estimated physiological (e.g. glycogen depletion) levels or capacities of a cyclist, and to use this route data 132 to route a cyclist between a start location and a destination location.

At block 1502, an anticipated total ride time, within a specified time period (e.g., one hour, two hours, 12 hours, 24 hours, two days) for a specific cyclist is received. In one example embodiment, this information is received from the provider application 110, having been inputted by a user (e.g., the cyclist). For example, a cyclist may indicate that he or she anticipates a total ride time for courier deliveries of 4 hours (anticipated ride time) within the next 24 hours (specific time period). The routine 1500, according to some example embodiments, seeks to optimize and personalize routing of the cyclist during the anticipated ride time to minimize physiological stress (e.g., because of glycogen depletion) so that the cyclist is not prevented from riding for the full 4 hours (and accordingly from making bike courier deliveries that may be a source of income for the cyclist).

To this end, at block 1504, a routing request is received at the service delivery system 102. The routing request indicates a route for the cyclist from a start location, identified by start application data to a destination location, identified by destination location data. The routing request is received at the routing engine 118 from matching system 124, based on the matching system 124 having matched a particular consumer request with a particular provider (e.g., the cyclist 602).

At block 1506, the routing engine 118 estimates a glycogen depletion value associated with the upcoming cycling trip, between the start and destination locations, for which route data is to be generated. The glycogen depletion value may be expressed in terms of glycogen calories and is an estimation of the number of glycogen calories that will be consumed during at least a portion or segment of the upcoming cycling trip. In one example embodiment, the glycogen depletion value may be estimated based on historical cycling information about the cyclist, as stored within the user database 136. In other embodiments, the glycogen depletion value may be estimated for the cyclist based on other variables and attributes for the cyclist (e.g., a weight of the cyclist, weight of a bicycle, or anticipated weight of a cycling unit comprising the cyclist, a bicycle, and a cargo).

At block 1508, the routing engine 118 proceeds to generate route data 132 for the upcoming cycling trip, based on the total anticipated ride time for the cyclist in the specified time period. For example, where a cyclist has expressed an intention to ride many hours within a current time period (e.g., a current day), the routing engine 118 may generate route data 132 that routes an upcoming cycling trip in a manner that minimizes glycogen depletion (e.g., consumes a minimum or lower number of glycogen calories). To this end, the routing engine 118 excludes segments from route data that exceed a predetermined gradient and will otherwise result in excessive glycogen consumption. In one embodiment, the generating of the route data 132 includes attributing a higher cost, in terms of a cost model 138 used by the routing engine 118, to route segments that incur a heavy glycogen depletion cost on a cyclist. To this end, each segment record 204 may include a glycogen depletion variable (not shown), that indicates a standard estimate for glycogen calories to be consumed by an average cyclist when traversing the relevant segment.

At block 1510, the route data 132 is provided by the routing engine 118 on a user interface of the provider application 110, executing on the provider device 108) to the cyclist. At block 1512, the service delivery system 102 tracks actual route data of the provider device 108, relative to the route data 132. Specifically, the tracking system 130 receives real-time and continuous location updates from the provider application 110. The routine 1500 then terminates at block 1414.

The service delivery system 102 accordingly adds an “extra cost” for glycogen depletion in calculating the route data 132, particularly if a cyclist is expected to ride a certain number of hours in a day. A typical cyclist can replenish to about 1500 glycogen calories, and the routing engine 118 may operate with assumptions that a cyclist has a certain amount of daily reserves of glycogen (e.g., 1-2 hours).

In a further embodiment, the routing engine 118 may track expected/estimated glycogen reserves of a particular cyclist during the specified time (e.g., a 24-hour time). If these glycogen reserves are anticipated to be consumed at a rate faster than their expected daily resupply rate, the routing engine 118 may, using the routine described above, actively avoid routing the cyclist on hill climbing or steeply ascending segments to prevent anticipated glycogen reserves from dropping below a predetermined threshold during the day. In addition, a cyclist may specify a minimum glycogen reserve to be maintained within a time period (e.g., 24 hours), and request that the routing engine 118 avoid any segments when generating route data 132 for the cyclist during that time that causes estimated glycogen reserves to drop below that threshold. In a further embodiment, the provider application 110 provides the cyclist with a report (e.g. via an appropriate user interface) of how much glycogen the cyclist is expected to deplete (or has already depleted), and accordingly how much replenishment may be needed. The provider application 110 may also provide the cyclist with replenishment alerts to prompt the cyclist to replenish their glycogen reserves (e.g., to consume a certain number of calories within a specified timeframe).

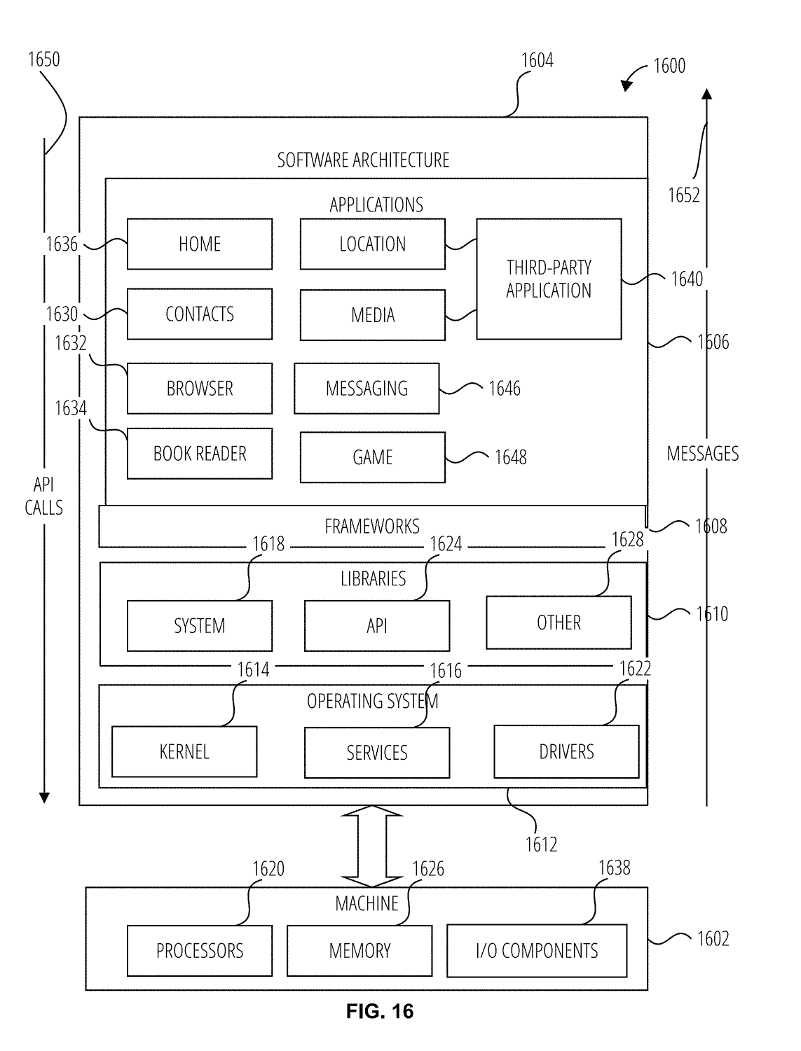

FIG. 16 is a block diagram 1600 illustrating a software architecture 1604, which can be installed on any one or more of the devices described above. FIG. 16 is merely a non-limiting example of a software architecture, and it will be appreciated that many other architectures can be implemented to facilitate the functionality described herein. In various embodiments, the software architecture 1604 is implemented by hardware such as a machine 1602 that includes processors 1620, memory 1626, and I/O components 1638. In this example architecture, the software architecture 1604 can be conceptualized as a stack of layers where each layer may provide a particular functionality. For example, the software architecture 1604 includes layers such as an operating system 1612, libraries 1610, frameworks 1608, and applications 1606. Operationally, the applications 1606 invoke Application Programming Interface (API) calls 1650 through the software stack and receive messages 1652 in response to the Application Programming Interface (API) calls 1650.

The operating system 1612 manages hardware resources and provides common services. The operating system 1612 includes, for example, a kernel 1614, services 1616, and drivers 1622. The kernel 1614 acts as an abstraction layer between the hardware and the other software layers, consistent with some embodiments. For example, the kernel 1614 provides memory management, processor management (e.g., scheduling), component management, networking, and security settings, among other functionality. The services 1616 can provide other common services for the other software layers. The drivers 1622 are responsible for controlling or interfacing with the underlying hardware, according to some embodiments. For instance, the drivers 1622 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

The libraries 1610 provide a low-level common infrastructure utilized by the applications 1606. The libraries 1610 can include system libraries 1618 (e.g., C standard library) that can provide functions such as memory allocation functions, string manipulation functions, mathematic functions, and the like. In addition, the libraries 1610 can include API libraries 1624 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1610 can also include a wide variety of other libraries 1628 to provide many other APIs to the applications 1606.

The frameworks 1608 provide a high-level common infrastructure that can be utilized by the applications 1606, according to some embodiments. For example, the frameworks 1608 provide various graphic user interface (GUI) functions, high-level resource management, high-level location services, and so forth. The frameworks 1608 can provide a broad spectrum of other APIs that can be utilized by the applications 1606, some of which may be specific to a particular operating system or platform.

The applications 1606 include a home application 1636, a contacts application 1630, a browser application 1632, a book reader application 1634, a location application 1642, a media application 1644, a messaging application 1646, a game application 1648, and a broad assortment of other applications such as a third-party application 1640. According to some embodiments, the applications 1606 are programs that execute functions defined in the programs. Various programming languages can be employed to create one or more of the applications 1606, structured in a variety of manners, such as object-oriented programming languages (e.g., Objective-C, Java, or C++) or procedural programming languages (e.g., C or assembly language). In a specific example, the third-party application 1640 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1640 can invoke the Application Programming Interface (API) calls 1650 provided by the operating system 1612 to facilitate functionality described herein.

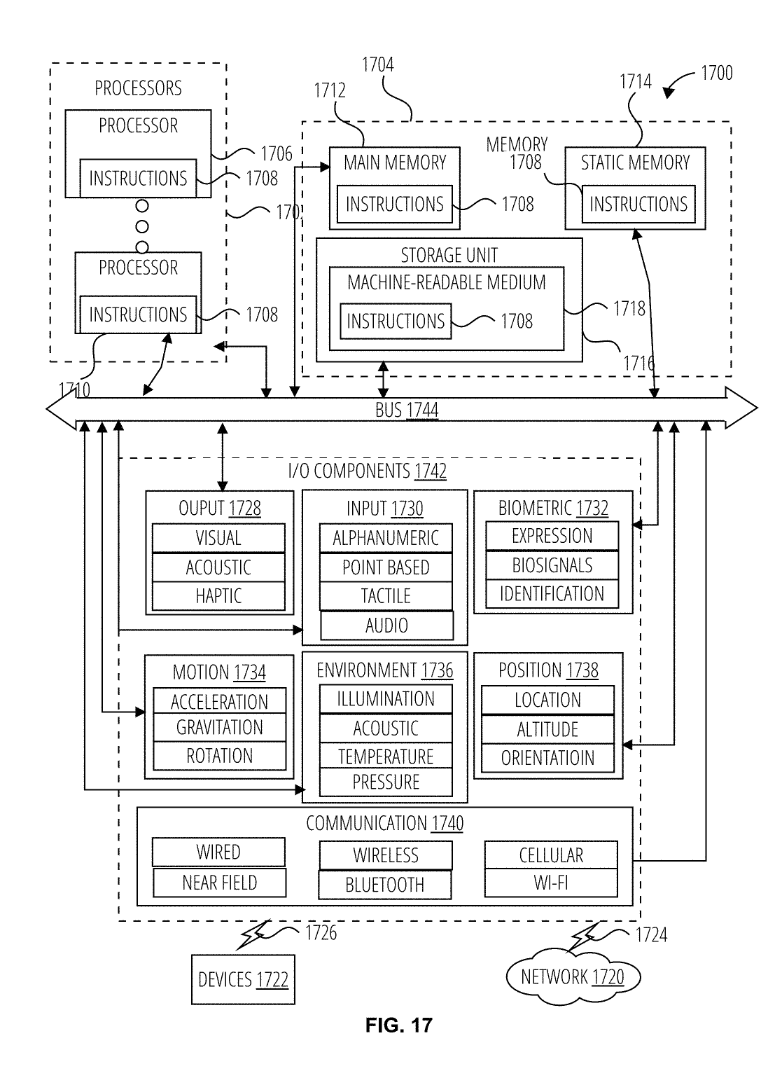

FIG. 17 illustrates a diagrammatic representation of a machine 1700 in the form of a computer system within which a set of instructions (e.g., a routine) may be executed for causing the machine to perform any one or more of the methodologies discussed herein, according to an example embodiment. Specifically, FIG. 17 shows a diagrammatic representation of the machine 1700 in the example form of a computer system, within which instructions 1708 (e.g., software, a program, an application, an applet, an app, or other executable code) for causing the machine 1700 to perform any one or more of the methodologies discussed herein may be executed. For example, the instructions 1708 may cause the machine 1700 to execute a method as described with reference to any one or more of the preceding diagrams. The instructions 1708 transform the general, non-programmed machine 1700 into a particular machine 1700 programmed to carry out the described and illustrated functions in the manner described. In alternative embodiments, the machine 1700 operates as a standalone device or may be coupled (e.g., networked) to other machines. In a networked deployment, the machine 1700 may operate in the capacity of a server machine or a client machine in a server-client network environment, or as a peer machine in a peer-to-peer (or distributed) network environment. The machine 1700 may comprise, but not be limited to, a server computer, a client computer, a personal computer (PC), a tablet computer, a laptop computer, a netbook, a set-top box (STB), a PDA, an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 1708, sequentially or otherwise, that specify actions to be taken by the machine 1700. Further, while only a single machine 1700 is illustrated, the term “machine” shall also be taken to include a collection of machine 1700 that individually or jointly execute the instructions 1708 to perform any one or more of the methodologies discussed herein.

The machine 1700 may include processors 1702, memory 1704, and I/O components 1742, which may be configured to communicate with each other such as via a bus 1744. In an example embodiment, the processors 1702 (e.g., a Central Processing Unit (CPU), a Reduced Instruction Set Computing (RISC) processor, a Complex Instruction Set Computing (CISC) processor, a Graphics Processing Unit (GPU), a Digital Signal processor (DSP), an ASIC, a Radio-Frequency Integrated Circuit (RFIC), another processor, or any suitable combination thereof) may include, for example, a processor 1706 and a processor 1710 that may execute the instructions 1708. The term “processor” is intended to include multi-core processors that may comprise two or more independent processors (sometimes referred to as “cores”) that may execute instructions contemporaneously. Although FIG. 17 shows multiple processors 1702, the machine 1700 may include a single processor with a single core, a single processor with multiple cores (e.g., a multi-core processor), multiple processors with a single core, multiple processors with multiples cores, or any combination thereof.

The memory 1704 may include a main memory 1712, a static memory 1714, and a storage unit 1716, both accessible to the processors 1702 such as via the bus 1744. The main memory 1704, the static memory 1714, and storage unit 1716 store the instructions 1708 embodying any one or more of the methodologies or functions described herein. The instructions 1708 may also reside, completely or partially, within the main memory 1712, within the static memory 1714, within machine-readable medium 1718 within the storage unit 1716, within at least one of the processors 1702 (e.g., within the processor's cache memory), or any suitable combination thereof, during execution thereof by the machine 1700.

The I/O components 1742 may include a wide variety of components to receive input, provide output, produce output, transmit information, exchange information, capture measurements, and so on. The specific I/O components 1742 that are included in a particular machine will depend on the type of machine. For example, portable machines such as mobile phones will likely include a touch input device or other such input mechanisms, while a headless server machine will likely not include such a touch input device. It will be appreciated that the I/O components 1742 may include many other components that are not shown in FIG. 17. The I/O components 1742 are grouped according to functionality merely for simplifying the following discussion and the grouping is in no way limiting. In various example embodiments, the I/O components 1742 may include output components 1728 and input components 1730. The output components 1728 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1730 may include alphanumeric input components (e.g., a keyboard, a touchscreen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touchscreen that provides location and/or force of touches or touch gestures, or other tactile input components), audio input components (e.g., a microphone), and the like.

In further example embodiments, the I/O components 1742 may include biometric components 1732, motion components 1734, environmental components 1736, or position components 1738, among a wide array of other components. For example, the biometric components 1732 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1734 may include acceleration sensor components (e.g., accelerometer), gravitation sensor components, rotation sensor components (e.g., gyroscope), and or a combination of such sensors that operate as an inertial motion unit (IMU). The environmental components 1736 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1738 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1742 may include communication components 1740 operable to couple the machine 1700 to a network 1720 or devices 1722 via a coupling 1724 and a coupling 1726, respectively. For example, the communication components 1740 may include a network interface component or another suitable device to interface with the network 1720. In further examples, the communication components 1740 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1722 may be another machine or any of a wide variety of peripheral devices (e.g., a peripheral device coupled via a USB).

Moreover, the communication components 1740 may detect identifiers or include components operable to detect identifiers. For example, the communication components 1740 may include Radio Frequency Identification (RFID) tag reader components, NFC smart tag detection components, optical reader components (e.g., an optical sensor to detect one-dimensional barcodes such as Universal Product Code (UPC) barcode, multi-dimensional bar codes such as Quick Response (QR) code, Aztec code, Data Matrix, Dataglyph, MaxiCode, PDF417, Ultra Code, UCC RSS-2D barcode, and other optical codes), or acoustic detection components (e.g., microphones to identify tagged audio signals). In addition, a variety of information may be derived via the communication components 1740, such as location via Internet Protocol (IP) geolocation, location via Wi-Fi® signal triangulation, location via detecting an NFC beacon signal that may indicate a particular location, and so forth.

The various memories (i.e., memory 1704, main memory 1712, static memory 1714, and/or memory of the processors 1702) and/or storage unit 1716 may store one or more sets of instructions and data structures (e.g., software) embodying or utilized by any one or more of the methodologies or functions described herein. These instructions (e.g., the instructions 1708), when executed by processors 1702, cause various operations to implement the disclosed embodiments. The instructions 1708 may be transmitted or received over the network 1720 using a transmission medium via a network interface device (e.g., a network interface component included in the communication components 1740) and utilizing any one of several well-known transfer protocols (e.g., hypertext transfer protocol (HTTP)). Similarly, the instructions 1708 may be transmitted or received using a signal medium via the coupling 1726 (e.g., a peer-to-peer coupling) to the devices 1722.

### EXAMPLES

### Example 1

A method to personalize route data relating to a cyclist riding a bicycle, the method comprising:

using at least one sensor of a mobile device, determining that the bicycle is in motion;
using the at least one sensor and responsive to the determination that the bicycle is in motion, capturing motion pattern data relating to the cyclist;
processing, using at least one processor of the mobile device, the motion pattern data relating the cyclist to automatically generate cycling profile data for the cyclist;
automatically updating a stored cyclist profile, stored in a system database, for the cyclist using the cycling profile data; and
receiving a routing request to provide a route for the cyclist, the request including start location data and destination location data;
responsive to receiving the routing request:
accessing the stored cyclist profile within the system database; and
personalizing route data for an automatically calculated route for the cyclist, using the stored cyclist profile.

### Example 2

The method according to any one of the preceding examples, including receiving input profile data from a user, and updating the stored cyclist profile, stored in the system database, for the cyclist using the input profile data.

### Example 3

The method according to any one of the preceding examples, wherein the processing, using a processor of the mobile device, of the motion pattern data relating the cyclist comprises generating estimated pedal cadence data.

### Example 4

The method according to any one of the preceding examples wherein the processing, using the processor of the mobile device, of the motion pattern data comprise deriving frequency data from the motion pattern data and generating the estimated pedal cadence data based on the frequency data.

### Example 5

The method according to any one of the preceding examples, wherein the at least one sensor comprises an accelerometer, and the motion pattern data includes both side-to-side motion data and back-and-forth motion data.

### Example 6

The method according to any one of the preceding examples wherein the at least one sensor comprises a gyroscope, and the motion pattern data includes rotational motion data.

### Example 7

The method according to any one of the preceding examples wherein the at least one sensor comprises an inertial motion unit (IMU), and motion pattern data includes both linear and angular motion data

### Example 8

The method according to any one of the preceding examples, further comprising:

using the at least one sensor and responsive to the determination that the bicycle is in motion, capturing location data relating to the cyclist;
processing, using the at least one processor of the mobile device, the location data to generate location profile data for the cyclist; and
automatically updating the stored cyclist profile, stored in a system database, for the cyclist using the location profile data.

### Example 9

The method according to any one of the preceding examples wherein the location data identifies a route segment of a past route traveled by the cyclist, and the processing comprises identifying the route segment as a shortcut route segment used by the cyclist on the past route.

### Example 10

The method according to any one of the preceding examples, including, based on the identifying of the route segment as a shortcut route segment, automatically updating a shortcut affinity value of the stored cyclist profile, the shortcut affinity value indicating an affinity of the cyclist to use shortcuts while cycling.

### Example 11

The method according to any one of the preceding examples including, based on the identifying of the route segment as a shortcut route segment, automatically determining that the shortcut route segment is not a prohibited route segment; and

responsive to determining that the shortcut route segment is not a prohibited route segment, updating a shortcut segment indication for the shortcut route segment in a route segment database maintained by a routing engine.

### Example 12

The method according to any one of the preceding examples, including, based on identifying the route segment as a shortcut route segment, automatically determining that the shortcut route segment is a prohibited route segment; and

responsive to determining that to the shortcut route segment is a prohibited route segment, automatically issuing a communication to the cyclist regarding usage of the shortcut route segment.

### Example 13

The method according to any one of the preceding examples, wherein the location data identifies a route segment of a past route traveled by the cyclist, and the processing comprises identifying the route segment as a transit route segment used by the cyclist during the past route.

### Example 14

The method according to any one of the preceding examples, including, based on the identifying of the route segment as a transit route segment, automatically updating a transit option affinity value of the stored cyclist profile, the transit option affinity value indicating an affinity of the cyclist to use transit options on a cycling route.

### Example 15

The method according to any one of the preceding examples, wherein the location data identifies an avoided route segment of a past route traveled by the cyclist, the avoided route segment being a route segment of a past calculated route that was avoided by cyclist, the method comprising flagging the avoided route segment in a map database maintained by a routing engine.

### Example 16

The method according to any one of the preceding examples, comprising automatically issuing an investigation request related to the avoided route segment responsive to the flagging thereof in the map database.

### Example 17

A method to estimate pedal cadence of a cyclist riding a bicycle using a mobile device, the method comprising:

using a first sensor of the mobile device, determining that the bicycle is in motion;
using a second sensor and responsive to the determination that the bicycle is in motion, capturing motion pattern data relating to the cyclist; and
processing, using a processor of the mobile device, the motion pattern data relating the cyclist to derive estimated pedal cadence data.

### Example 18

The method according to any one of the preceding examples, wherein the first sensor comprises a global positioning system (GPS) sensor, and the determining includes determining a speed of motion of the bicycle.

### Example 19

The method according to any one of the preceding examples, wherein the second sensor comprises an accelerometer, and the motion pattern data includes both side-to-side motion data and back-and-forth motion data.

### Example 20

The method according to any one of the preceding examples, wherein the second sensor comprises a gyroscope, and the motion pattern data includes rotational motion data.

### Example 21

The method according to any one of the preceding examples, wherein the second sensor comprises an inertial motion unit (IMU), and motion pattern data includes both linear and angular motion data.

### Example 22

The method according to any one of the preceding examples, wherein the processing, using the processor of the mobile device, of the motion pattern data comprise deriving frequency data from the motion pattern data and estimating the pedal cadence data based on the frequency data.

### Example 23

The method according to any one of the preceding examples, including, using a third sensor, determining that the bicycle is ascending, and capturing the motion pattern data responsive to the determination that the bicycle is ascending.

### Example 24

The method according to any one of the preceding examples, wherein the third sensor comprises at least one of a barometric altimeter or a GPS altimeter.

### Example 25

The method according to any one of the preceding examples, including generating estimated power data based on the estimated pedal cadence data.

### Example 26

The method according to any one of the preceding examples, including generating bicycle routing data based on the estimated pedal cadence data.

### Example 27

The method according to any one of the preceding examples, including performing a first determination that the mobile device is operationally mounted on-bike and, responsive to the first determination, processing the motion pattern data according to a first algorithm to derive the estimated pedal cadence data.

### Example 28

The method according to any one of the preceding examples, including performing a second determination that the mobile device is operationally located on-body the cyclist at a first body location and, responsive to the second determination, processing the motion pattern data according to a second algorithm to drive the estimated pedal cadence data.

### Example 29

The method according to any one of the preceding examples, wherein the first body location is an upper-body location on the cyclist.

### Example 30

The method according to any one of the preceding examples, including performing a third determination that the mobile device is operationally located on-body the cyclist at a second body location and, responsive to the third determination, processing the motion pattern data according to the first algorithm to derive the estimated pedal cadence data.

### Example 31

The method according to any one of the preceding examples, wherein the second body location is a lower-body location on the cyclist.

### Example 32

A method to generate bicycle routing data, the method comprising:

receiving pedal cadence data for a cyclist;
deriving a minimum cadence value for the cyclist based on the pedal cadence data; and
automatically calculating route data for the cyclist based on the minimum cadence value; providing the route data for a route to a mobile device of the cyclist; and
using the mobile device, tracking actual route data compared to the route data.

### Example 33

The method according to any one of the preceding examples, wherein the calculating of the route data includes:

receiving a start location data and a destination location data for the route;
identifying the grade of a segment of the route between the start location data and the destination location data;
estimating a threshold gear length for a specific bicycle of the cyclist;
using the grade of the segment and the estimated threshold gear length for the specific bicycle, determining that an estimated cadence for ascending the segment exceeds the minimum cadence value; and
excluding the segment from the route between the start location data and the destination location data.

### Example 34

The method according to any one of the preceding examples, identifying at least one alternative segment to the excluded segment, and including the at least one alternative segment into the route between the start location data and the destination location data.

### Example 35

The method according to any one of the preceding examples, wherein the estimating of the threshold gear length for the specific bicycle of the cyclist includes receiving speed data and cadence data from a cycling trip by the cyclist on the specific bicycle, and calculating the estimated threshold gear length using the speed of data and the cadence data.

### Example 36

The method according to any one of the preceding examples, wherein the deriving of the minimum cadence value comprises deriving an optimum cadence range for the cyclist based on the pedal cadence data, and the calculating of the route data includes, for a specific bicycle, determining a route between a start location data and a destination location data that maintains an active cadence of the cyclist on ascending segments on the route within the optimum cadence range.

### Example 37

The method according to any one of the preceding examples, wherein the receiving of the pedal cadence data includes generating estimated pedal cadence data for the cyclist riding a bicycle using a mobile device, the method comprising:

using a first sensor of the mobile device, determining that the bicycle is in motion;
using a second sensor and responsive to the determination that the bicycle is in motion, capturing motion pattern data relating to the cyclist; and
processing, using a processor of the mobile device, the motion pattern data relating the cyclist to derive the estimated pedal cadence data.

### Example 38

The method according to any one of the preceding examples, including receiving input from a user, the input including the pedal cadence data.

### Example 39

A method to generate bicycle routing data, the method comprising:

receiving anticipated total ride time within a specific time period for a cyclist;
receiving a start location data and destination location data for an upcoming cycling trip for the cyclist during the specific time period;
based on historical cycling information pertaining to the cyclist, estimating a glycogen depletion value associated with the upcoming cycling trip; and
calculating route data for the upcoming cycling trip based on the anticipated total ride time and the estimated glycogen depletion value exceeding a threshold value for the anticipated total ride time;
providing the route data for the upcoming cycling trip a mobile device of the cyclist; and
using the mobile device, tracking actual route data compared to the route data.

### Example 41

The method according to any one of the preceding examples, wherein the calculating of the route data comprises substituting segments of an initial route that exceeded a power consumption rate threshold for the cyclist to generate a modified route.

What is claimed is:

1. A method to personalize route data relating to a cyclist riding a bicycle, the method comprising:
receiving motion pattern data relating to the cyclist, the motion pattern data having been generated by at least one sensor of a mobile device;
generating, using at least one processor, generate cycling profile data for the cyclist based on the motion pattern data;
automatically updating a stored cyclist profile, stored in a system database, for the cyclist using the cycling profile data;
receiving a routing request to provide a route for the cyclist, the request including start location data and destination location data;
responsive to receiving the routing request:
accessing the stored cyclist profile within the system database; and
personalizing route data for an automatically calculated route for the cyclist, using the stored cyclist profile.

2. The method of claim 1, including receiving input profile data from a user, and updating the stored cyclist profile, stored in the system database, for the cyclist using the input profile data.

3. The method of claim 1, including generating, using the at least one processor, estimated pedal cadence data based on the motion pattern data.

4. The method of claim 3, wherein the generating of the pedal cadence data includes deriving frequency data from the motion pattern data and generating the estimated pedal cadence data based on the frequency data.

5. The method of claim 1, wherein the at least one sensor comprises an accelerometer, and the motion pattern data includes both side-to-side motion data and back-and-forth motion data.

6. The method of claim 1, wherein the at least one sensor comprises a gyroscope, and the motion pattern data includes rotational motion data.

7. The method of claim 1, wherein the at least one sensor comprises an inertial motion unit (IMU), and motion pattern data includes both linear and angular motion data

8. The method of claim 1, further comprising:
receiving location data relating to the cyclist;
processing, using the at least one processor, the location data to generate location profile data for the cyclist; and
automatically updating the stored cyclist profile, stored in the system database, for the cyclist using the location profile data.

9. The method of claim 8, wherein the location data identifies a route segment of a past route traveled by the cyclist, and the processing comprises identifying the route segment as a shortcut route segment used by the cyclist on the past route.

10. The method of claim 9, including, based on the identifying of the route segment as a shortcut route segment, automatically updating a shortcut affinity value of the stored cyclist profile, the shortcut affinity value indicating an affinity of the cyclist to use shortcuts while cycling.

11. The method of claim 8, wherein the location data identifies a route segment of a past route traveled by the cyclist, and the processing comprises identifying the route segment as a transit route segment used by the cyclist during the past route.

12. The method of claim 11, including, based on the identifying of the route segment as a transit route segment, automatically updating a transit option affinity value of the stored cyclist profile, the transit option affinity value indicating an affinity of the cyclist to use transit options on a cycling route.

13. The method of claim 8, wherein the location data identifies an avoided route segment of a past route traveled by the cyclist, the avoided route segment being a route segment of a past calculated route that was avoided by the cyclist, the method comprising flagging the avoided route segment in a map database maintained by a routing engine.

14. A computing apparatus, the computing apparatus comprising:
at least one processor; and
a memory storing instructions that, when executed by the at least one processor, configure the apparatus to perform operations comprising:
receiving motion pattern data relate to a cyclist, the motion pattern data having been generated by at least one sensor of a mobile device;
generating, using the at least one processor, cycling profile data for the cyclist based on the motion pattern data;
automatically updating a stored cyclist profile, stored in a system database, for the cyclist using the cycling profile data;
receiving a routing request to provide a route for the cyclist, the request including start location data and destination location data;
responsive to receiving the routing request:
accessing the stored cyclist profile within the system database; and
personalizing route data for an automatically calculated route for the cyclist, using the stored cyclist profile.

15. The computing apparatus of claim 14, wherein the operations further comprise, generating, using the at least one processor, estimated pedal cadence data based on the motion pattern data, the generating of the pedal cadence data including deriving frequency data from the motion pattern data and generating the estimated pedal cadence data based on the frequency data.

16. The computing apparatus of claim 14, wherein the at least one sensor comprises an accelerometer, and the motion pattern data includes both side-to-side motion data and back-and-forth motion data.

17. The computing apparatus of claim 14, wherein the at least one sensor comprises a gyroscope, and the motion pattern data includes rotational motion data.

18. The computing apparatus of claim 14, wherein the at least one sensor comprises an inertial motion unit (IMU), and motion pattern data includes both linear and angular motion data

19. The computing apparatus of claim 14, wherein the instructions further configure the apparatus to perform operations comprising:
receiving location data relate to the cyclist;
processing, using the at least one processor, the location data to generate location profile data for the cyclist; and
automatically updating the stored cyclist profile, stored in the system database, for the cyclist using the location profile data.

20. A machine-storage medium storing instructions that, when executed by one or more processors of a machine, cause the one or more processors to perform operations comprising:
receiving motion pattern data relate to a cyclist, the motion pattern data having been generated by at least one sensor of a mobile device;
generating, using at least one processor, cycling profile data for the cyclist based on the motion pattern data;
automatically updating a stored cyclist profile, stored in a system database, for the cyclist using the cycling profile data;
receiving a routing request to provide a route for the cyclist, the request including start location data and destination location data;
responsive to receiving the routing request:
access the stored cyclist profile within the system database; and
personalize route data for an automatically calculated route for the cyclist, using the stored cyclist profile.
